(19) United States
(12) Patent Application Publication
(10) Pub. No.: US 2026/0222560 A1
(43) Pub. Date: Jul. 30, 2026

(54) METHOD AND APPARATUS FOR CHROMA CODING

(71) Applicant: GUANGDONG OPPO MOBILE TELECOMMUNICATIONS CORP., LTD., Dongguan (CN)

(72) Inventors: Yue YU, Dongguan (CN); Haoping YU, Dongguan (CN); Jonathan GAN, Dongguan (CN)

(73) Assignee: GUANGDONG OPPO MOBILE TELECOMMUNICATIONS CORP., LTD., Dongguan (CN)

(21) Appl. No.: 19/575,514

(22) Filed: Mar. 23, 2026

Related U.S. Application Data
(63) Continuation of application No. PCT/CN2024/121197, filed on Sep. 25, 2024.
(60) Provisional application No. 63/540,331, filed on Sep. 25, 2023.

(51) Int. Cl. H04N 19/11; H04N 19/176; H04N 19/186; H04N 19/70

(52) U.S. Cl. CPC H04N 19/11; H04N 19/176; H04N 19/186; H04N 19/70

(57) ABSTRACT

A method of decoding by a decoder is provided. The method may include, in response to a co-located luma block being coded using intra template matching (intraTMP) or intra block copy (IBC), determining, by a processor, a corresponding chroma block is eligible for prediction using a fused block vector guided (FBVG)-convolutional cross-component intra prediction model (CCCM) (FBVG-CCCM) mode. The method may include parsing, by the processor, a bitstream to obtain an FBVG-CCCM flag. The method may include, in response to the FBVG-CCCM flag indicating the FBVG-CCCM mode is selected for the corresponding chroma block, generating, by the processor, a FBVG-CCCM mode prediction of the corresponding chroma block. A decoder and a method of encoding by an encoder are also provided.

### CROSS-REFERENCE TO RELATED APPLICATIONS

This is a continuation of International Patent Application No. PCT/CN2024/121197, filed on Sep. 25, 2024, which claims the benefit of priority to U.S. Provisional Application No. 63/540,331, entitled “IMPROVED CHROMA CODING” and filed on Sep. 25, 2023. The disclosures of the two applications are incorporated by reference herein in their entirety.

### BACKGROUND

Embodiments of the present disclosure relate to video coding.

Digital video has become mainstream and is being used in a wide range of applications including digital television, video telephony, and teleconferencing. These digital video applications are feasible because of the advances in computing and communication technologies as well as efficient video coding techniques. Various video coding techniques may be used to compress video data, such that coding on the video data can be performed using one or more video coding standards. Exemplary video coding standards may include, but not limited to, versatile video coding (H.266/VVC), high-efficiency video coding (H.265/HEVC), advanced video coding (H.264/AVC), moving picture expert group (MPEG) coding, enhanced video coding model (ECM), to name a few.

### SUMMARY

According to one aspect of the present disclosure, a method of decoding by a decoder is provided. The method may include, in response to a co-located luma block being coded using intra template matching (intraTMP) or intra block copy (IBC), determining, by a processor, a corresponding chroma block is eligible for prediction using a fused block vector guided (FBVG)-convolutional cross-component intra prediction model (CCCM) (FBVG-CCCM) mode. The method may include parsing, by the processor, a bitstream to obtain an FBVG-CCCM flag. The method may include, in response to the FBVG-CCCM flag indicating the FBVG-CCCM mode is selected for the corresponding chroma block, generating, by the processor, a FBVG-CCCM mode prediction of the corresponding chroma block.

According to another aspect of the present disclosure, a decoder is provided. The decoder may include a processor and memory storing instructions. The memory storing instructions, which when executed by the processor, may cause the processor to, in response to a co-located luma block being coded using intraTMP or IBC, determine a corresponding chroma block is eligible for prediction using an FBVG-CCCM mode. The memory storing instructions, which when executed by the processor, may cause the processor to parse a bitstream to obtain an FBVG-CCCM flag. The memory storing instructions, which when executed by the processor, may cause the processor to, in response to the FBVG-CCCM flag indicating the FBVG-CCCM mode is selected for the corresponding chroma block, generate a FBVG-CCCM mode prediction of the corresponding chroma block.

According to yet a further aspect of the present disclosure, a method of encoding by an encoder is provided. The method may include, in response to a co-located luma block being coded using intraTMP or IBC, determining, by a processor, a corresponding chroma block is eligible for prediction using an FBVG-CCCM mode. The method may include encoding, by the processor, an FBVG-CCCM flag. The method may include, in response to the FBVG-CCCM flag indicating the FBVG-CCCM mode is selected for the corresponding chroma block, generating, by the processor, a FBVG-CCCM mode prediction of the corresponding chroma block.

According to still another aspect of the present disclosure, a non-transitory computer-readable medium is provided. The non-transitory computer-readable medium has instructions and a bitstream stored thereon, and the instructions, when executed by a processor, enable the processor to perform the steps of the encoding method described above to generate the bitstream.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary encoder in the encoding system in FIG. 1, according to some embodiments of the present disclosure.

FIG. 4 illustrates a detailed block diagram of an exemplary decoder in the decoding system in FIG. 2, according to some embodiments of the present disclosure.

FIG. 5 illustrates an exemplary picture divided into coding tree units (CTUs), according to some embodiments of the present disclosure.

FIG. 6 illustrates an exemplary CTU divided into coding units (CUs), according to some embodiments of the present disclosure.

FIG. 7 illustrates a schematic visualization of a current CU block and spatially adjacent and non-adjacent reconstructed samples to the current block, according to some embodiments of the present disclosure.

FIG. 8 illustrates a schematic visualization of the angular modes of VVC, according to some embodiments of the present disclosure.

FIG. 9A illustrates a diagram of slice partitioning for intra prediction, according to some embodiments of the present disclosure.

FIG. 9B illustrates a diagram of tile partitioning for intra prediction, according to some embodiments of the present disclosure.

FIG. 9C illustrates a diagram of wavefront-parallel processing for intra prediction, according to some embodiments of the present disclosure.

FIG. 10A illustrates a diagram of intra block copy (IBC), according to some embodiments of the present disclosure.

FIG. 10B illustrates a diagram of intra template matching prediction (intraTMP), according to some embodiments of the present disclosure.

FIG. 10C illustrates a diagram of an extended search region for intraTMP, according to some embodiments of the present disclosure.

FIG. 11 illustrates a diagram of fractional-pel positions for intraTMP, according to some embodiments of the present disclosure.

FIG. 12 illustrates a diagram of a direct block vector (DBV) mode, according to some embodiments of the present disclosure.

FIG. 13 illustrates a diagram of DBV prediction, according to some embodiments of the present disclosure.

FIG. 14 illustrates a diagram of a spatial component of a convolutional cross-component intra prediction model (CCCM) filter, according to some embodiments of the present disclosure.

FIG. 15 illustrates a diagram of a reference area used to calculate a CCCM filter, according to some embodiments of the present disclosure.

FIG. 16 illustrates reference areas used to calculate a block vector guided CCCM (BVG-CCCM) filter, according to some embodiments of the present disclosure.

FIGS. 17A and 17B illustrate a flowchart of a method of decoding, according to some embodiments of the present disclosure.

FIGS. 18A and 18B illustrate a flowchart of a method of encoding, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of video coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video coding applications. As described herein, video coding includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block” and “unit” may be used interchangeably.

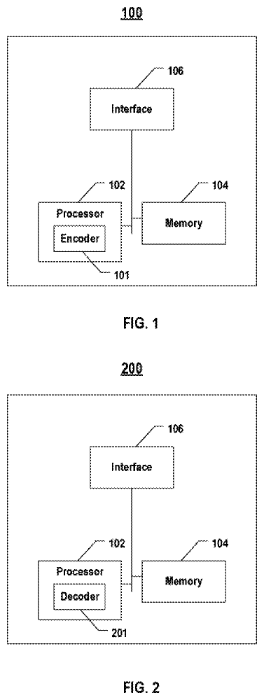

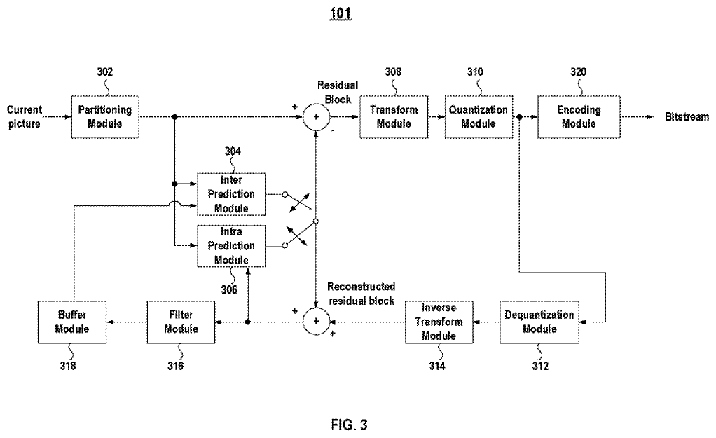

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatus capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 1 and 2, system 100 or 200 may include a processor 102, a memory 104, and an interface 106. These components are shown as connected to one another by a bus, but other connection types are also permitted. It is understood that system 100 or 200 may include any other suitable components for performing functions described here.

Processor 102 may include microprocessors, such as a graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 1 and 2, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a. secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 1 and 2, it is understood that multiple memories can be included.

Interface 106 can broadly include a data interface and a communication interface that is configured to receive and transmit a signal in a process of receiving and transmitting information with other external network elements. For example, interface 106 may include input/output (I/O) devices and wired or wireless transceivers. Although only one interface is shown in FIGS. 1 and 2, it is understood that multiple interfaces can be included.

Processor 102, memory 104, and interface 106 may be implemented in various forms in system 100 or 200 for performing video coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated on an application processor (AP) SoC that handles application processing in an operating system (OS) environment, including running video encoding and decoding applications. In another example, processor 102, memory 104, and interface 106 may be integrated on a specialized processor chip for video coding, such as a GPU or ISP chip dedicated to image and video processing in a real-time operating system (RTOS).

As shown in FIG. 1, in encoding system 100, processor 102 may include one or more modules, such as an encoder 101. Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, e.g., instructions. The instructions of the program may be stored on a computer-readable medium, such as memory 104, and when executed by processor 102, it may perform a process having one or more functions related to video encoding, such as picture partitioning, inter prediction, intra prediction, transformation, quantization, filtering, entropy encoding, etc., as described below in detail.

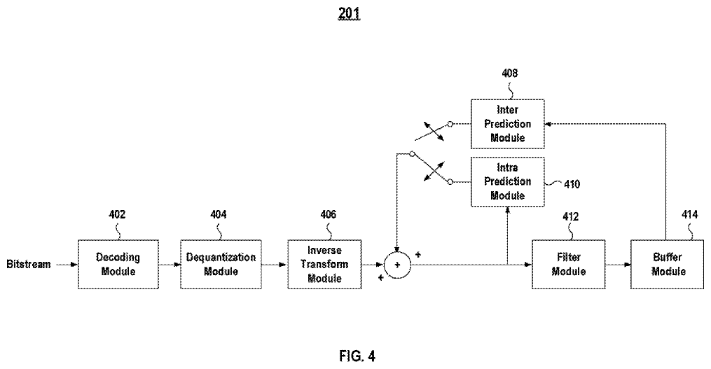

Similarly, as shown in FIG. 2, in decoding system 200, processor 102 may include one or more modules, such as a decoder 201. Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, e.g., instructions. The instructions of the program may be stored on a computer-readable medium, such as memory 104, and when executed by processor 102, it may perform a process having one or more functions related to video decoding, such as entropy decoding, inverse quantization, inverse transformation, inter prediction, intra prediction, filtering, as described below in detail. FIG. 3 illustrates a detailed block diagram of exemplary encoder 101 in encoding system 100 in FIG. 1, according to some embodiments of the present disclosure. As shown in FIG. 3, encoder 101 may include a partitioning module 302, an inter prediction module 304, an intra prediction module 306, a transform module 308, a quantization module 310, a dequantization module 312, an inverse transform module 314, a filter module 316, a buffer module 318, and an encoding module 320. It is understood that each of the elements shown in FIG. 3 is independently shown to represent characteristic functions different from each other in a video encoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on encoder 101.

Partitioning module 302 may be configured to partition an input picture of a video into at least one processing unit. A picture can be a frame of the video or a field of the video. In some embodiments, a picture includes an array of luma samples in monochrome format, or an array of luma samples and two corresponding arrays of chroma samples. At this point, the processing unit may be a prediction unit (PU), a transform unit (TU), or a coding unit (CU). Partitioning module 302 may partition a picture into a combination of a plurality of coding units, prediction units, and transform units, and encode a picture by selecting a combination of a coding unit, a prediction unit, and a transform unit based on a predetermined criterion (e.g., a cost function).

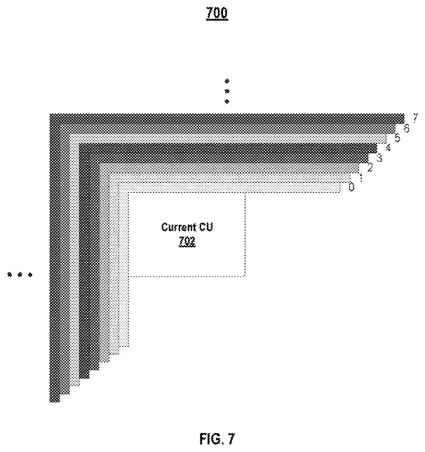

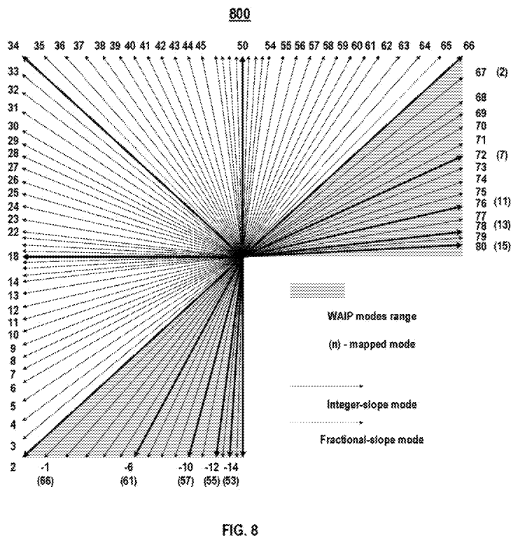

Similar to H.265/HEVC, H.266/VVC is a block-based hybrid spatial and temporal predictive coding scheme. As shown in FIG. 5, during encoding, an input picture 500 is first divided into square blocks-CTUs 502, by partitioning module 302. For example, CTUs 502 can be blocks of 128×128 pixels. As shown in FIG. 6, each CTU 502 in input picture 500 can be partitioned by partitioning module 302 into one or more CUs 602, which can be used for prediction and transformation. Unlike H.265/HEVC, in H.266/VVC, CUs 602 can be rectangular or square, and can be coded without further partitioning into prediction units or transform units. For example, as shown in FIG. 6, the partition of CTU 502 into CUs 602 may include quadtree splitting (indicated in solid lines), binary tree splitting (indicated in dashed lines), and ternary splitting (indicated in dash-dotted lines). Each CU 602 can be as large as its root CTU or be subdivisions of root CTU 502 as small as 4×4 blocks, according to some embodiments.

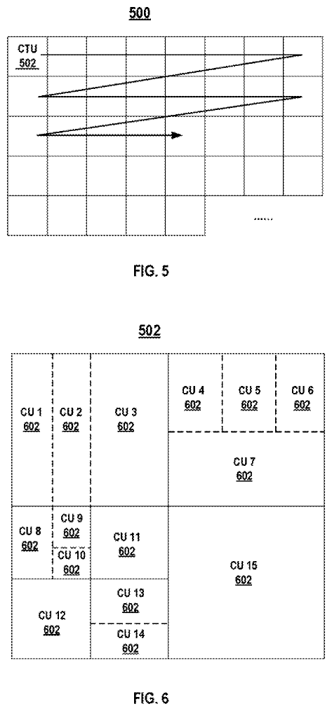

Referring to FIG. 4, inter prediction module 304 may be configured to perform inter prediction on a prediction unit, and intra prediction module 306 may be configured to perform intra prediction on the prediction unit. It may be determined whether to use inter prediction or to perform intra prediction for the prediction unit, and determine specific information (e.g., intra prediction mode, motion vector, reference picture, etc.) according to each prediction method. At this point, a processing unit for performing prediction may be different from a processing unit for determining a prediction method and specific content. For example, a prediction method and a prediction mode may be determined in a prediction unit, and prediction may be performed in a transform unit. Residual coefficients in a residual block between the generated prediction block and the original block may be input into transform module 308. In addition, prediction mode information, motion vector information, and the like used for prediction may be encoded by encoding module 320 together with the residual coefficients or quantization levels into the bitstream. It is understood that in certain encoding modes, an original block may be encoded as it is without generating a prediction block through prediction module 304 or 306. It is also understood that in certain encoding modes, prediction, transform, and/or quantization may be skipped as well.

In some embodiments, inter prediction module 304 may predict a prediction unit based on information on at least one picture among pictures before or after the current picture, and in some cases, it may predict a prediction unit based on information on a partial area that has been encoded in the current picture. Inter prediction module 304 may include sub-modules, such as a reference picture interpolation module, a motion prediction module, and a motion compensation module (not shown). For example, the reference picture interpolation module may receive reference picture information from buffer module 318 and generate pixel information of an integer number of pixels or less from the reference picture. In the case of a luminance pixel, a discrete cosine transform (DCT)-based 8-tap interpolation filter with a varying filter coefficient may be used to generate pixel information of an integer number of pixels or less by the unit of ¼ pixels. In the case of a color difference signal, a DCT-based 4-tap interpolation filter with a varying filter coefficient may be used to generate pixel information of an integer number of pixels or less by the unit of ⅛ pixels. The motion prediction module may perform motion prediction based on the reference picture interpolated by the reference picture interpolation part. Various methods, such as a full search-based block matching algorithm (FBMA), a three-step search (TSS), and a new three-step search algorithm (NTS) may be used as a method of calculating a motion vector. The motion vector may have a motion vector value of a unit of ½, ¼, or 1/16 pixels or integer pel based on interpolated pixels. The motion prediction module may predict a current prediction unit by varying the motion prediction method. Various methods, such as a skip method, a merge method, an advanced motion vector prediction (AMVP) method, an intra-block copy method, and the like, may be used as the motion prediction method.

Still referring to FIG. 3, in some embodiments, intra prediction module 306 may generate a prediction unit based on the information on reference pixels around the current block, which is pixel information in the current picture. The reference pixels may be located in reference lines non-adjacent to the current block. When a block in the neighborhood of the current prediction unit is a block on which inter prediction has been performed and thus, the reference pixel is a pixel on which inter prediction has been performed, the reference pixel included in the block on which inter prediction has been performed may be used in place of reference pixel information of a block in the neighborhood on which intra prediction has been performed. That is, when a reference pixel is unavailable, at least one reference pixel among available reference pixels may be used in place of unavailable reference pixel information. In the intra prediction, the prediction mode may have an angular prediction mode that uses reference pixel information according to a prediction direction, and a non-angular prediction mode that does not use directional information when performing prediction. A mode for predicting luminance information may be different from a mode for predicting color difference information, and intra prediction mode information used to predict luminance information or predicted luminance signal information may be used to predict the color difference information. If the size of the prediction unit is the same as the size of the transform unit when intra prediction is performed, the intra prediction may be performed for the prediction unit based on pixels on the left side, pixels on the top-left side, and pixels on the top of the prediction unit. However, if the size of the prediction unit is different from the size of the transform unit when the intra prediction is performed, the intra prediction may be performed using a reference pixel based on the transform unit.

The intra prediction method may generate a prediction block after applying an adaptive intra smoothing (AIS) filter to the reference pixel according to a prediction mode. The type of the AIS filter applied to the reference pixel may vary. In order to perform the intra prediction method, the intra prediction mode of the current prediction unit may be predicted from the intra prediction mode of the prediction unit existing in the neighborhood of the current prediction unit. When a prediction mode of the current prediction unit is predicted using the mode information predicted from the neighboring prediction unit, if the intra prediction modes of the current prediction unit are the same as the prediction unit in the neighborhood, information indicating that the prediction modes of the current prediction unit are the same as the prediction unit in the neighborhood may be transmitted using predetermined flag information, and if the prediction modes of the current prediction unit and the prediction unit in the neighborhood are different from each other, prediction mode information of the current block may be encoded by extra flags information.

As shown in FIG. 3, a residual block including a prediction unit that has performed prediction based on the prediction unit generated by prediction module 304 or 306 and residual coefficient information (also referred to herein as the “residual”), which is a difference value of the prediction unit with the original block, may be generated. The generated residual block may be input into transform module 308. Additional details of residuals and transforms for video coding will now be provided.

In hybrid video coding systems, redundancy in the video signal is first exploited by applying inter or intra prediction tools for each CU. The difference between the original samples of a CU and the prediction block for that CU is commonly referred to as the residual. Even after prediction, the residual may still be highly spatially correlated. Although conditional entropy coding can capture some spatial dependency between adjacent samples, it is computationally impractical to form entropy coding statistical models that can fully exploit spatial correlation in the residual. In contrast, transform coding is a practical and effective method for spatially decorrelating the residual.

For example, transform module 308 may transform the residual using an integerized version of the two-dimensional discrete cosine transform (DCT), which may be applied separably in the horizontal and vertical directions. For an M×N block of residual samples (where M is the width of the block and N is the height of the block), transform module 308 may obtain transform coefficients by applying an M×M DCT to each row, resulting in intermediate transform coefficients, and then applying an N×N DCT to each column of intermediate transform coefficients.

For intra-coded CUs (also referred to herein as “intra CUs”), spatial neighboring reconstructed samples are used to predict the current block, and the intra prediction mode is signaled once for the entire CU. Each CU consists of one or more collocated coding blocks (CBs) corresponding to the color components of the video sequence. For example, consumer video typically takes the 4:2:0 chroma format, in which case each CU consists of a luma CB and two chroma CBs with one-quarter of the samples of the luma CB. Intra prediction and transform coding are performed at the prediction block (PB) and transform block (TB) levels, respectively. Each CB consists of a single TB, except in the cases of Intra Subpartition (ISP) mode and implicit splitting. For luma CBs, the maximum side length of a TB is 64, and the minimum side length is 4. In addition, luma TBs are further specified as W×H rectangular blocks of width W and height H, where W, H∈{4, 8, 16, 32, 64}. For chroma CBs, the maximum TB side length is 32, and chroma TBs are rectangular W×H blocks of width W and height H. Here, W, H∈{2, 4, 8, 16, 32}, but blocks of shapes 2×H and 4×2 are excluded in order to address memory architecture and throughput requirements.

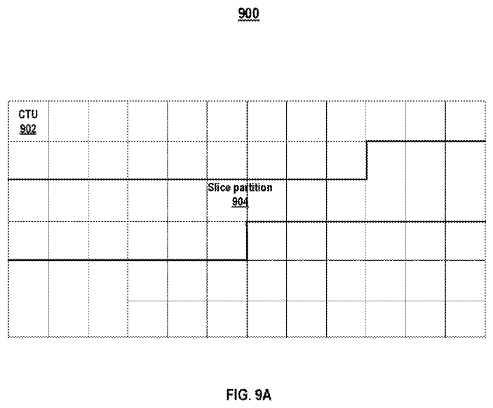

FIG. 7 illustrates a schematic visualization 700 of a current CU block 702 and spatially adjacent and non-adjacent reconstructed samples to the current block, according to some aspects of the present disclosure. In FIG. 7, the number 0, 1, 2, . . . indicates the pixel-line index in relation to current CU block 702.

In VVC, the intra prediction samples for the current block are generated using reference samples that are obtained from reconstructed samples of neighboring blocks. For a W×H block, the reference samples are spatially adjacent to the current block, consisting of the vertical line of 2·H reconstructed samples to the left of the block and extending downwards, the top left reconstructed sample, and the horizontal line of 2·W reconstructed samples above the current block and extending to the right. This “L” shaped set of samples may be referred to in this disclosure as a “reference line.” The reference line directly adjacent to current CU block 702 is shown as the line with index 0 in FIG. 7.

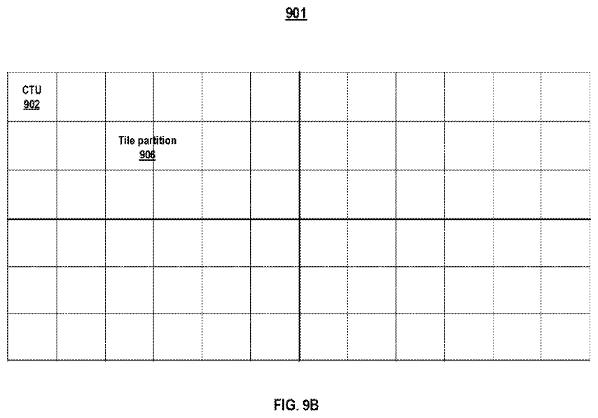

Similar to AVC and HEVC, VVC also supports angular intra prediction modes. Angular intra prediction is a directional intra prediction method. In comparison to HEVC, the angular intra prediction of VVC was modified by increasing the prediction accuracy and by an adaptation to the new partitioning framework. The former was realized by enlarging the number of angular prediction directions and by more accurate interpolation filters, while the latter was achieved by introducing wide-angular intra prediction modes. In VVC, the number of directional modes available for a given block is increased to 65 directions from the 33 HEVC directions. The angular modes 800 of VVC are depicted in FIG. 8.

The directions having even indices between 2 and 66 are equivalent to the directions of the angular modes supported in HEVC. For blocks of square shape, an equal number of angular modes is assigned to the top and left side of a block. On the other hand, intra blocks of rectangular shape, which are not present in HEVC, are a central part of VVC's partitioning scheme with additional intra prediction directions assigned to the longer side of a block. The additional modes allocated along a longer side are called Wide-Angle Intra Prediction (WAIP) modes, since they correspond to prediction directions with angles greater than 45° relative to the horizontal or vertical mode. A WAIP mode for a given mode index is defined by mapping the original directional mode to a mode that has the opposite direction with an index offset equal to one, as shown in FIG. 8. For a given rectangular block, the aspect ratio, e.g., the ratio of width to height, is used to determine which angular modes are to be replaced by the corresponding wide-angular modes.

For square-shaped blocks in VVC, each pair of predicted samples that are horizontally or vertically adjacent are predicted from a pair of adjacent reference samples. To the contrary, WAIP extends the angular range of directional prediction beyond 45°, and therefore, for a coding block predicted with a WAIP mode, adjacent predicted samples may be predicted from non-adjacent reference samples.

In addition to the directly adjacent line of neighboring samples, one of the two non-adjacent reference lines (line 1 and line 2) that are depicted in FIG. 7 may include the input samples for intra prediction in VVC. For ECM, more non-adjacent reference lines may be used. The use of adjacent and non-adjacent reference samples is referred to as multiple reference line (MRL) prediction.

The intra modes that can be used for MRL are the DC mode and the angular prediction modes. However, for a given block, not all of these modes can be combined with MRL. The MRL mode is always coupled with a mode in the Most Probable Mode (MPM) list in VVC. This coupling means that if non-adjacent reference lines are used, the intra prediction mode is one of the MPMs. Such a design of an MPM-based MRL prediction mode is motivated by the observation that non-adjacent reference lines are mainly beneficial for texture patterns with sharp and strongly directed edges. In these cases, MPMs are much more frequently selected since there is typically a strong correlation between the texture patterns of the neighboring and the current blocks. On the other hand, choosing a non-MPM for intra prediction is an indication that edges are not consistently distributed in neighboring blocks, and thus, the MRL prediction mode is expected to be less useful in this case. In addition, it has been observed that MRL does not provide additional coding gain when the intra prediction mode is the Planar mode, since this mode is typically used for smooth areas. Consequently, MRL excludes the Planar mode, which is always one of the MPMs. The angular or DC prediction process in MRL is very similar to the case of a directly adjacent reference line. However, for angular modes with a non-integer slope, a DCT-based interpolation filter (DCTIF) is always used. This design choice is both evidenced by experimental results and aligned with the empirical observation that MRL is mostly beneficial for sharp and strongly directed edges where the DCTIF is more appropriate since it retains more high frequencies than some other filters.

From a hardware design perspective, applying multiple reference lines as proposed in the initial methods requires extra cost of line buffers that are used for holding the additional reference lines. In typical hardware designs, line buffers are part of the on-chip memory architecture for image and video coding, and it is of great importance to minimize their on-chip area. To address this issue, MRL is disabled and not signaled for the coding units that are attached to the top boundary of the CTU. In this way, the extra buffers for holding non-adjacent reference lines are bounded by 128, which is the width of the largest unit size.

In some known approaches, an intra prediction fusion method was proposed to improve the accuracy of intra prediction. More specifically, if the current block is a luma block, and it is coded with a non-integer slope angular mode and not in the ISP mode, and the block size (width*height) is greater than 16, two prediction blocks generated from two different reference lines will be “fused,” where the prediction fusion is calculated as a weighted summation of the two prediction blocks. More specifically, a first reference line at index i (lineᵢ) is specified with the current methods of signaling in the bitstream, and the prediction block generated from this reference line using the selected intra prediction mode is denoted as p(lineᵢ), where p(⋅) represents the operation of generating a prediction block from a reference line with a given intra prediction mode. In the known approach, the reference line lineᵢ₊₁ is implicitly selected as the second reference line. That is, the second reference line is one index position further away from the current block relative to the first reference line. Similarly, the prediction block generated from the second reference line is denoted as p(lineᵢ₊₁). The weighted sum of the two prediction blocks is obtained as follows and serves as the predictor for the current block according to equation (1).

$${p}_{fusion} = {w}_{0} * p ( {line}_{i} ) + {w}_{1} * p ( {line}_{i + 1} ) , \qquad ( 1 )$$

where p_{fusion} represents the fused prediction, w₀ and w₁ are two weighting factors, and they are set as ¾ and ¼ in the experiment, respectively.

In the intra prediction methods described above, a predictor is derived dependent on neighboring reference samples. However, this is itself dependent on the reference samples being available to the current CU. Availability of samples depends on two factors: 1) whether the samples have already been reconstructed, and 2) whether the samples belong to a logical unit that the current CU is permitted to use.

To determine whether samples have already been reconstructed, we consider the partitioning structure of VVC. Referring to FIG. 5, each picture is divided into a tiling of square CTUs, which are processed in raster scan order. When an intra prediction method is performed on a current CU 602 in a current CTU 502, samples belonging to other CTUs preceding current CTU 502 in raster scan order are reconstructed and may be available for prediction. Samples belonging to CTUs following the current CTU 502 in raster scan order are not reconstructed and, therefore, are not available.

Each CTU 502 itself is partitioned into CUs by a hierarchical structure consisting of quadtree, binary tree, and ternary tree splits, with an example of such splits shown in FIG. 6. The scan order of CUs within a CTU 502 is determined by the partitioning structure. For a single level of partitioning split, the partitions are scanned in the following order: 1) left to right for the cases of horizontal binary tree split or horizontal ternary tree split, 2) top to bottom for the cases of vertical binary tree split or vertical ternary tree split, and 3) top-left, top-right, bottom-left, bottom-right for the case of quadtree split.

If a partition contains further hierarchical splits, then all CUs within that partition are scanned before continuing to the CUs in the next partition. FIG. 6 shows an example of partitioning of a CTU 502 into 15 CUs. Each CU 602 in FIG. 6 is numbered from 1 to 15 to indicate their scan order. When an intra prediction method is performed on a current CU in a current CTU, samples belonging to other CUs in the current CTU that precede the current CU in the current CTU's partitioning scan order are reconstructed and may be available for prediction. Samples belonging to the current CU, or CUs following the current CU in the current CTU's partitioning scan order are not reconstructed and, therefore, not available.

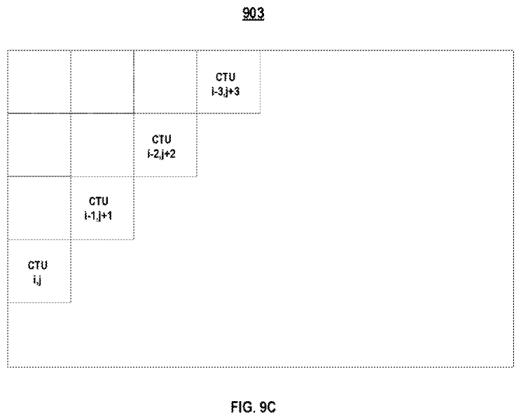

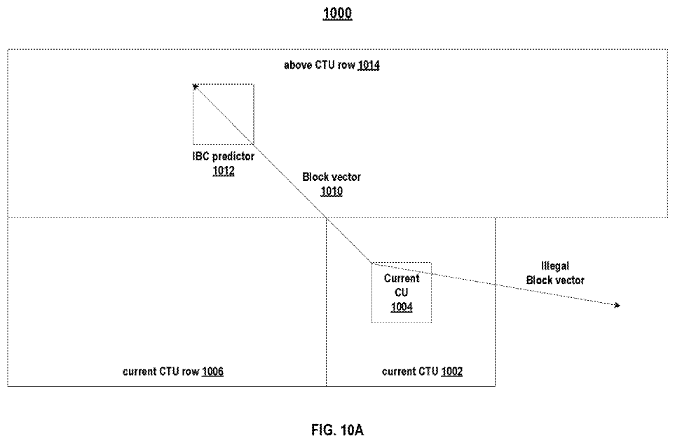

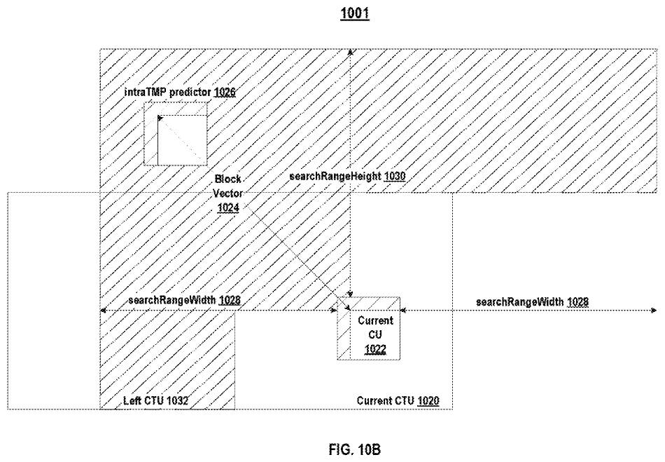

Samples belonging to a CTU preceding the current CTU in raster scan order are considered reconstructed by the definition above. However, they are not necessarily available for intra prediction. To be considered available for prediction, they must also belong to a logical unit that the current CU is permitted to use. Pictures may be divided into sub-picture partitions, each of which contains a whole number of CTUs. FIG. 9A illustrates a diagram of slice partitioning 900 of a picture for intra prediction, according to some embodiments of the present disclosure. Samples belonging to a slice partition 904 other than the slice containing the current CU (of CTU 902) are not available for intra prediction. Imposing this restriction allows slices to be decoded independently.

FIG. 9B illustrates a diagram of tile partitioning 901 of a picture for intra prediction, according to some embodiments of the present disclosure. Samples belonging to a tile partition 906 other than the tile containing the current CU (of CTU 902) are not available for intra prediction. Imposing this restriction allows tiles to be decoded independently.

FIG. 9C illustrates a diagram of wavefront-parallel processing 903 of a picture for intra prediction, according to some embodiments of the present disclosure.

The manner in which an intra prediction method (e.g., slice partitioning, tile partitioning, or wavefront-parallel processing) deals with unavailability of reference samples needed for prediction varies depending on the method. The method may simply be disabled when such samples are not available. Alternatively, some extrapolation of the unavailable samples may be performed, such as by boundary extension.

In the intra prediction methods described above with reference to FIGS. 9A-9C, the predictor is derived only from spatially neighboring reference samples. However, greater coding gain can be achieved by expanding the region of reconstructed samples that may be used to derive a predictor. One example of this is with the intra block copy (IBC) mode.

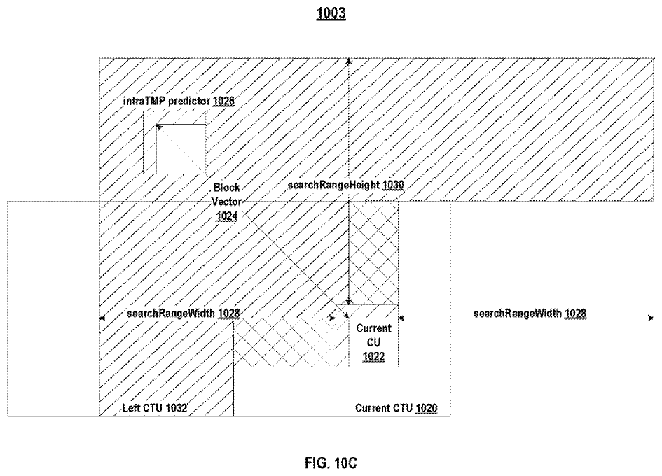

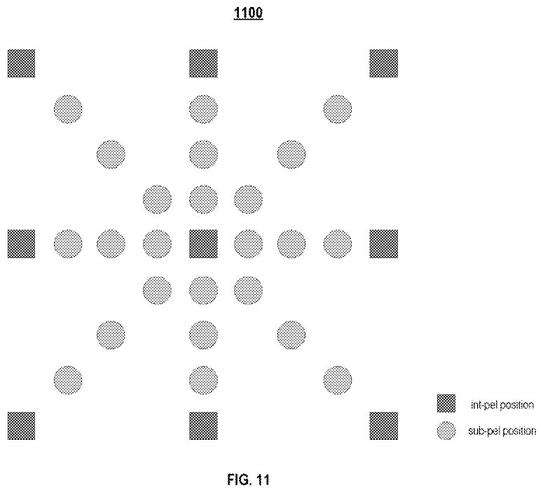

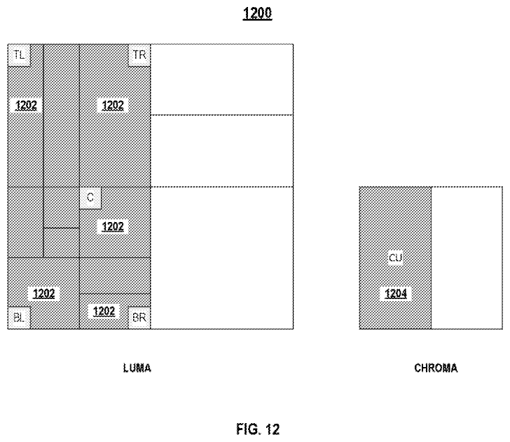

FIG. 10A illustrates a diagram of IBC 1000, according to some embodiments of the present disclosure.

Referring to FIG. 10A, when a current CU 1004 is predicted by intra block copy mode, a block vector (BV) 1010 is signalled to indicate which block within the same picture will be copied to serve as a predictor 1012 for the current block. Signalling of this block vector may by performed by signalling a block vector difference (BVD) in the bitstream, such that the block vector can be determined by adding the BVD to a block vector predictor. Alternatively, if a block vector from a previous CU is an exact match for the current block vector, it may be signalled by a merge flag. Regardless of the signalling mechanism, the block vector points at a location within the same picture to indicate a block of samples equal in size to the current CU 1004 that is used as a predictor block for the current CU 1004. Some restrictions may apply to the block vector. In a first restriction, the block vector 1010 may point at a block of samples in the current picture that are available for intra prediction. In a second restriction, the block vector 1010 may be restricted to a search region defined for the IBC tool, which may be smaller than the current picture. For example, in VVC the IBC search region is current CTU 1002 and the previous CTU. In ECM the IBC search region is the current CTU row 1006 and the above CTU row 1014 when the CTU size is 256×256, or the current CTU row 1006 and the above 2 CTU rows when the current CTU size is 128×128 or smaller.

To further improve coding performance, a fractional-pel IBC method was proposed in ECM-9.0. More specifically, a 1/16-pel resolution is supported in addition to the existing full-pel IBC. The 8-tap luma filter as well as the chroma filter used in VVC for fractional motion compensation are used to interpolate the fractional-pel values. After an IBC block is coded, the 1/16-pel resolution is stored for coding future blocks.

FIG. 10B illustrates a diagram of intraTMP 1001, according to some embodiments of the present disclosure.

Referring to FIG. 10B, intraTMP is an intra prediction mode similar to IBC in that the current CU 1022 is also predicted by a block of samples from the current picture. intraTMP may only be selected as a prediction mode for CUs with size 64×64 or smaller. Unlike IBC, however, a block vector 1024 is not signalled in the bitstream in intraTMP. Instead, decoder 201 compares a pre-defined L-shaped or other shaped templates of reconstructed samples neighbouring the current CU 1022 against the same shaped templates of candidate predictors within a predetermined search region. For the case where the template is L-shaped, both neighbouring samples to the left and above of the current CU 1022 or intraTMP predictor 1026 are used. Let the width of the template area to the left be TmpW, and let the width of the template area above be TmpH. Other template shapes include a left template, which only includes the template area to the left, and an above template, which only consists of the template area above.

The intraTMP predictor block is determined by finding the best candidate template that matches the current CU template. The best match may be determined by finding the template that minimizes the sum of absolute differences (SAD), or the sum of absolute transformed differences (SATD), or by comparing hashes between templates. The search algorithm through the search region may be exhaustive (for example, by scanning the template over the search region with sample-resolution shifts), or fast (for example, by performing a coarse search first, then performing a local refinement search around the best match from the coarse search). Regardless, the search algorithm is performed identically by both the encoder and decoder so that the intraTMP predictor is implicitly known by both encoder 101 and decoder 201 without requiring signalling in the bitstream. An example of intraTMP is shown in FIG. 10B with the current CU template and the best matching template indicated by hatched shading.

Still referring to FIG. 10B, for an intraTMP predictor 1026 to be selected, the block of samples corresponding to intraTMP predictor 1026 must be fully contained within the search region. The search region is shown in FIG. 10B by dashed shading. Within the current CTU 1020, the search region is restricted to a rectangular block of samples, bounded at one corner by the top-left corner of the current CTU 1020, and bounded at the other corner by the top-left corner of the current CU 1022.

Outside of the current CTU 1020, the search region is limited by imposing maximum lengths on the intraTMP block vector of (searchRangeWidth 1028, searchRangeHeight 1030), where searchRangeWidth 1028 and searchRangeHeight 1030 are set proportional to the dimensions of the current CU 1022. That is, the searchRangeWidth=a*BlkW and searchRangeHeight=a*BlkH, where ‘a’ is a constant that controls the gain/complexity trade-off, and BlkW and BlkH are the width and height of the current CU 1022, respectively. Here, ‘a’ is set to 5 in the ECM-7.0 test software. searchRangeHeight 1030 only limits the length of the block vectors in the negative vertical direction (that is, in the direction to the top of the picture). For block vectors with a positive vertical component, the search region is limited by the bottom boundary of the current CTU row. For example, in FIG. 10B, the search region extends to the bottom boundary of the left CTU 1032, regardless of the value of searchRangeHeight 1030. In addition, these limits to the search range do not apply to the current CTU 1020. For example, for small CUs where searchRangeWidth 1028 and searchRangeHeight 1030 may be small compared to the dimensions of current CTU 1020, the search region still extends as far as the top-left corner of the current CTU 1020.

Beyond the restriction imposed by the search region, the intraTMP predictor 1026 and its template must consist of samples that are available for intra prediction. For example, the boundaries of the search region are still overridden by picture, slice, or tile boundaries. Let the coordinates of the top-left corner of the currentCU relative to the current picture be (currCuX, currCuY). Then, the left boundary of the intraTMP search region is initially intraTmpLeftBound=currCuX−searchRangeWidth. To account for the picture boundary, the left boundary is clipped to allow TmpW sample width for the predictor's template. intraTmpLeftBound=max(intraTmpLeftBound, TmpW)

To speed up the template matching process, the search region is initially traversed horizontally or vertically in increments of 2 pixels at a time. This is also referred to as a search sub-sampling factor of 2. This leads to a 4-fold reduction in the template matching search complexity. After finding the best match from the initial search, a refinement process is performed. The refinement is done via a second template matching search around the best match with a reduced range. In ECM-7.0, the reduced range is set to BlkH/2.

FIG. 10C illustrates a diagram of an extended search region for intraTMP 1003, according to some embodiments of the present disclosure.

Referring to FIG. 10C, for small CUs, the search range may be overly limiting so that a good predictor becomes difficult to obtain. For example, a 4×4 CU would only be allowed a maximum search range of (20, 20). To improve this situation for small CUs, some implementations place a minimum limit on the intraTMP search range. For example, searchRangeWidth=max(a*BlkW, minSearchRange) and searchRangeHight=max(a*BlkH, minSearchRange), where minSearchRange is set as 128.

This implementation excludes some regions in the current CTU 1020 that are available for prediction. Here, it is proposed to extend the search region in the current CTU 1020 to include areas directly above and directly left of the current CU 1022. The proposed modified search region is FIG. 10C, with the areas added to the search region relative to that of FIG. 10B marked with crosshatch shading.

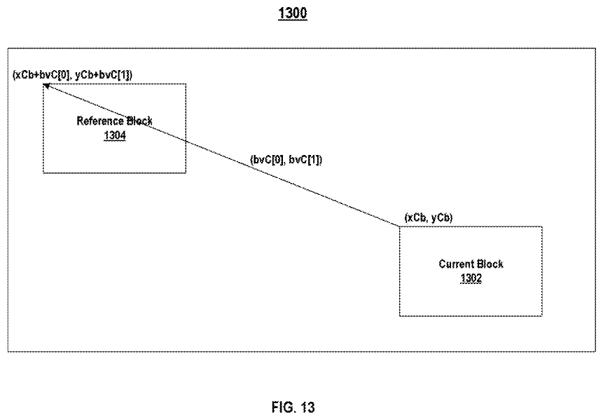

FIG. 11 illustrates a diagram of fractional-pel positions 1100 for intraTMP, according to some embodiments of the present disclosure.

Referring to FIG. 11, ECM-9.0 employs a multi-candidate intraTMP prediction method. A candidate list is constructed with the candidate BVs ranked in ascending order of their template matching costs. In other words, BV0 has the lowest template matching cost, BV1 has the next lowest template matching cost, and so on. The index of the selected candidate is signaled in the bitstream.

Fractional-pel precision is enabled for intraTMP in the ECM-9.0. More specifically, intraTMP block may have quarter-pel fractional resolution BV. Three fractional-pel offsets, e.g., half-pel, quarter-pel, and three quarter-pel, in eight directions around the integer-pel position are supported, resulting in fractional-pel positions as shown in FIG. 11. If a non-zero fractional-pel offset is signaled, a direction index is signaled to indicate which direction is used. Four-tap DCTIF interpolation filters in ECM are used for sub-pel interpolation in intraTMP.

ECM-9.0 also employs a model-derived intraTMP prediction block. The model parameters are derived using a template of the current block and a corresponding matching template. The prediction block is obtained by applying the model to filter the reference block.

ECM-9.0 employs a fusion method that blends multiple reference blocks to derive the final prediction block, with a Wiener-filter-based weight derivation method. The Block Vectors (BVs) of these reference blocks are obtained via a template matching search process.

Three additional intraTMP modes, e.g., left template, above template and L-shape fusion modes, are used in ECM-9.0. The left and above template modes use only the left side or above side to derive the template matching candidates, whereas the L-shape fusion mode uses both left and above templates. The fusion mode fuses the best two or the best five L-shape candidates by a template matching cost based or mean-square error (MSE) minimization based linear combination formula.

In the current ECM-9.0, the syntax related to intraTMP is shown in Table 1.

TABLE 1
intraTMP syntax elements in ECM-9.0

```
...
intra_tmp_flag
if(intra_tmp_flag) {
    intra_tmp_fusion_flag
    if(intra_tmp_fusion_flag) {
        intra_tmp_fusion_weight_type
        intra_tmp_fusion_idx
  } else{
  intra_tmp_idx
  intra_tmp_filter_flag
  if(!intra_tmp_filter_flag) {
    intra_tmp_sub_pel_precision_idx
    if(intra_tmp_sub_pel_precision_idx != 0) {
      intra_tmp_sub_pel_direction_idx
      }//if(intra_tmp_sub...)
    } // if(!intra_tmp_filter_flag)
  }//else
}// intra_tmp_flag
...
```

Referring to Table 1, intra_tmp_flag indicates whether the intra prediction type for the current block is intraTMP or not, intra_tmp_fusion_flag indicates whether fusion is used or not for the current block, and intra_tmp_fusion_idx specifies the candidate set used for intraTMP fusion. The range of intra_tmp_fusion_idx is 0 to 2, and intra_tmp_fusion_idx is used to indicate one of the three candidate sets {BV0 to BV4}, {BV5 to BV9}, {BV10 to BV14}. intra_tmp_fusion_weight_type indicates whether the SAD-based weight derivation method or the Wiener-filter-based weight derivation method is used. intra_tmp_idx specifies the index of BV in the candidate list used for the current block. The range of intra_tmp_idx is 0 to 18. Candidates from the L-shape template, top template and left template are included in the same candidate list. intra_tmp_sub_pel_precision_idx specifies the precision index for the current block. The range of intra_tmp_sub_pel_precision_idx is 0 to 3, used to indicate integer-pel precision, ½-pel precision, ¼-pel precision, and ¾-pel precision, respectively. intra_tmp_sub_pel_direction_idx specifies the sub-pel direction index for the current block. The range of intra_tmp_sub_pel_phase_idx is 0 to 7.

An intraTMP block may be coded with a fractional-pel BV resolution only if the current block is coded as neither fused intraTMP (e.g., intra_tmp_fusion_flag as 1) nor filtered intraTMP (e.g., intra_tmp_filter_flag as 1) in the current ECM-9.0. If a block is coded as either fused intraTMP or filtered intraTMP, the intraTMP block only has a BV in full-pel (integer-pel) resolution.

After an intraTMP block is coded, regardless of whether the current intraTMP coded block has an integer-pel or a quarter-pel fractional resolution BV, only integer-pel BV information for the current intraTMP block is stored for coding future blocks. More specifically, if the current intraTMP has a quarter-pel fractional BV, this quarter-pel fractional BV is rounded into the integer-pel resolution first. The integer-pel BV is then converted into 1/16-pel resolution (the current integer-pel BV left shift by 4). The converted 1/16-pel resolution BV is stored for coding future blocks in the ECM-9.0.

Referring again to FIG. 6, an example partitioning of a CTU 502 into CUs 602 is shown, where each CU 602 consists of three color components-one luma (Y) component, and two chroma (Cb and Cr) components. In such cases where all the color components are partitioned together, the partitioning structure is referred to as a single tree.

VVC supports an alternative partitioning structure for intra slices, where the luma component and the chroma components are partitioned independently. This structure may be referred to as a dual tree. This dual tree partitioning structure introduces an overhead used to signal partitioning splits for both the luma tree and the chroma tree. However, this additional signaling overhead may be outweighed by the benefit of greater flexibility in the partitioning structure, such as when larger chroma CUs can be signaled independent of the luma partitioning structure.

In single tree partitioning, each intra-predicted CU signals both a luma intra prediction mode and a chroma intra prediction mode. Because the luma intra prediction mode is signaled first, the chroma prediction mode may be determined using the information of the luma prediction mode. For example, a direct mode (DM) flag may be signaled to indicate that the chroma components copy the intra prediction direction of the luma component. That is, the chroma components will use the same intra prediction mode (as shown in FIG. 8) as the luma component.

In dual tree partitioning, the entire luma tree of luma CUs is decoded before the chroma tree is decoded, and therefore, the information such as the selected luma intra prediction mode of the co-located luma CU is available when the chroma intra prediction mode of a chroma CU is determined. Like the single tree case, a direct mode (DM) flag may be signaled to indicate that the chroma CU copies the intra prediction direction of the co-located luma CU. A direct block vector (DBV) flag may be signaled to indicate that the chroma CU copies the intraTMP or IBC block vector of the co-located luma CU.

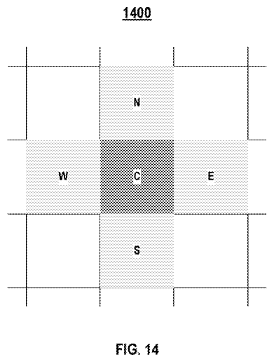

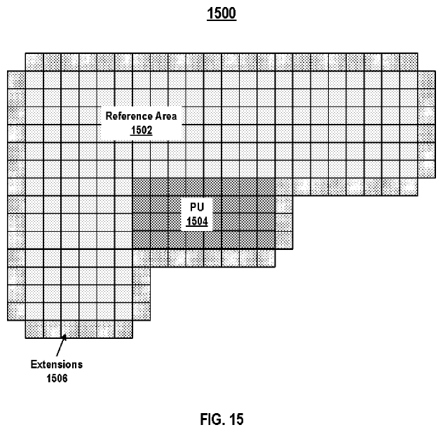

FIG. 12 illustrates a diagram of a direct block vector (DBV) mode 1200, according to some embodiments of the present disclosure. FIG. 13 illustrates a diagram of a DBV prediction process 1300, according to some embodiments of the present disclosure. FIGS. 12 and 13 will be described together.

Referring to FIG. 12, five corresponding luma blocks 1202 for a chroma block 1204 may be checked according to a pre-defined order, e.g., from center (C), top-left (TL), top-right (TR), bottom-left (BL), to the bottom-right (BR) block. If any one of these five luma blocks 1202 is coded with either the IBC mode or the intraTMP mode, the current chroma block 1204 is eligible for the DBV mode. Furthermore, once the DBV mode is selected, the BV of the first IBC or intraTMP coded luma block will be used to derive the BV for coding the current chroma block 1204.

For instance, referring to FIG. 13, the BV of the first luma block (bvL), which is coded with either the IBC or IntraTMP mode will be used to derive a BV for the current chroma block (bvC), where bvC[0] and bvC[1] represent the pixel displacements along horizontal and vertical directions relative to the top-left corner of the current chroma block, respectively. bvC may be derived by scaling bvL by the chroma sampling ratio. For example, when the chroma format is 4:2:0, which indicates that the chroma components are subsampled by 2 times in both the vertical and horizontal directions, bvC may be obtained by 0.5*bvL. The reference chroma block 1304 indicated by the derived bvC will be directly copied to predict the current chroma block 1302 shown in FIG. 13. Suppose that the coordinates of the top-left corner of the current chroma block 1302 are (xCb, yCb). The reference chroma block 1304 refers to the same size block whose coordinates of the top-left corner are (xCb+bvC[0], yCh+bvC[1]).

When a single tree partitioning is used, the chroma component and the corresponding luma component use the same partition. Currently, DBV is not allowed for a single tree partition. However, when the luma block of a single tree CU is coded with IBC, the chroma direct mode (DM) is interpreted to signal the same prediction as DBV. That is, when the corresponding chroma block's prediction mode is signaled as direct mode (DM), then the bvL is inherited by the corresponding chroma block to derive bvC, and is directly pointed at by a bvC when the corresponding luma mode is IBC.

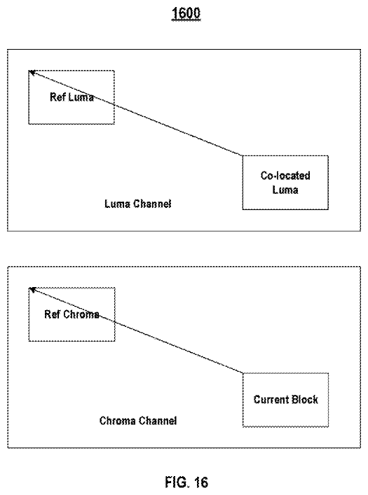

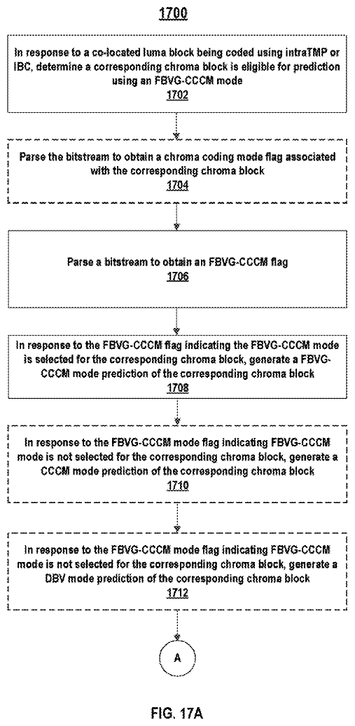

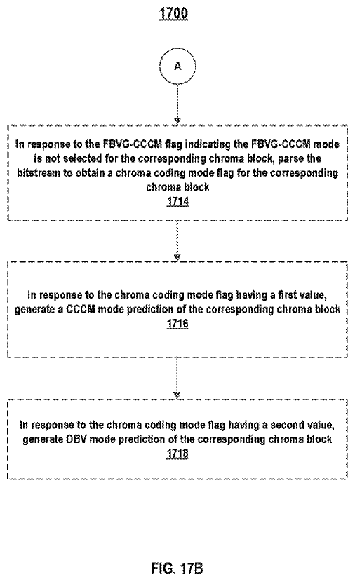

FIG. 14 illustrates a diagram of a spatial component 1400 of a convolutional cross-component intra prediction model (CCCM) filter, according to some embodiments of the present disclosure. FIG. 15 illustrates a diagram of a reference area 1500 used to calculate a CCCM filter, according to some embodiments of the present disclosure. FIG. 16 illustrates reference areas 1600 used to calculate a block vector guided CCCM (BVG-CCCM) filter, according to some embodiments of the present disclosure. FIGS. 14-16 will be described together.

Referring to FIG. 14, CCCM applies convolutional cross-component models to predict chroma samples from reconstructed luma samples. The reconstructed luma samples are down-sampled to match the lower resolution chroma grid when chroma sub-sampling is used. There may be more than one model to select. Therefore, there is an option of using a single model or multi-model variant of CCCM. The multi-model variant uses two models, one model derived for samples above the average luma reference value and another model for the rest of the samples. Multi-model CCCM mode can be selected for PUs, which have at least 128 reference samples available.

The 7-tap convolutional filter used for CCCM consists of a 5-tap plus sign shape spatial component, a nonlinear term P, and a bias term B. The input to the spatial 5-tap component of the filter consists of a center (C) luma sample, which is collocated with the chroma sample to be predicted and its above/north (N), below/south(S), left/west (W), and right/east (E) neighbors, as illustrated in FIG. 14.

The nonlinear term P is represented as power of two of the center luma sample C and scaled to the sample value range of the content, as shown below in equation (1).

$$P = ( C * C + midVal ) >> bit Depth . \qquad ( 1 )$$

That is, for 10-bit content, the non-linear term P is calculated as shown below in equation (2).

$$P = ( C * C + 512 ) >> 10. \qquad ( 2 )$$

The bias term B represents a scalar offset between the input and output and is set to middle chroma value (512 for 10-bit content).

The output of the filter is calculated as a convolution between the filter coefficients ci and the input values and clipped to the range of valid chroma samples, as shown below in equation (3).

$$predChromaVal = {c}_{0} C + {c}_{1} N + {c}_{2} S + {c}_{3} E + {c}_{4} W + {c}_{5} P + {c}_{6} B . \qquad ( 3 )$$

The filter coefficients ci are calculated by minimizing a mean-square error (MSE) between predicted and reconstructed chroma samples in the reference area. FIG. 15 illustrates the reference area 1502, which consists of 6 lines of chroma samples above and left of the prediction unit (PU) 1504. Reference area 1502 extends one PU width to the right and one PU height below the boundaries of the PU 1504. The reference area is adjusted to include only available samples. The extensions 1506 to the area shown in blue are needed to support the “side samples” of the plus shaped spatial filter and are padded when in unavailable areas.

The MSE minimization is performed by calculating an autocorrelation matrix for the luma input and a cross-correlation vector between the luma input and chroma output. The autocorrelation matrix is LDL decomposed, and the final filter coefficients are calculated using back-substitution. The process follows roughly the calculation of the adaptive loop filter (ALF) coefficients in ECM; however, LDL decomposition was chosen instead of Cholesky decomposition to avoid using square root operations. The approach uses only integer arithmetic.

Usage of the CCCM mode is signaled with a context adaptive binary arithmetic coding (CABAC) PU-level flag. One new CABAC context was included to support this. When it comes to signaling, CCCM may be considered a sub-mode of cross-component linear model (CCLM). That is, the CCCM flag is only signaled if intra prediction mode is LM_CHROMA_IDX (to enable single mode CCCM) or MMLM_CHROMA_IDX (to enable multi-model CCCM).

In the CCCM technique, spatial neighboring reconstructed areas shown in FIG. 15 are used to calculate the CCCM filter. Referring to FIG. 16, in the BVG-CCCM technique, block vectors (BV) of co-located luma blocks, coded in IBC or intraTMP modes, are used to determine reference areas (reference luma block) with arrows representing the luma and chroma BVs. Instead of the spatial neighboring areas, these reference areas are used to calculate the BVG-CCCM parameters. The BVG-CCCM uses the calculated filter parameters and co-located luma samples to form the CCCM prediction.

The BVG-CCCM mode is enabled only in intra slices. Moreover, a sequence parameter set (SPS)-level flag is introduced for enabling or disabling the mode. In addition, the BVG-CCCM mode uses an 11-tap filter for cross-component prediction, as shown below in equation (4).

$$predChromaVal = {c}_{0} C + {c}_{1} N + {c}_{2} S + {c}_{3} E + {c}_{4} W + {c}_{5} P ( C ) + {c}_{6} P ( N ) + {c}_{7} P ( S ) + {c}_{8} P ( W ) + {c}_{9} P ( E ) + {c}_{10} B . \qquad ( 4 )$$

The input to the spatial 5-tap component of the filter consists of a center (C) luma sample, which is collocated with the chroma sample to be predicted, and its above/north (N), below/south(S), left/west (W) and right/east (E) neighbors, as illustrated in FIG. 14. The nonlinear term P is represented as power of two of the corresponding luma sample, and B is the bias term.

To determine the block vectors from the co-located luma blocks, BVG-CCCM checks the same five locations as with the DBV mode shown in FIG. 12. With a dual tree partition, a chroma block may be coded as BVG-CCCM or DBV mode when the corresponding luma is coded as either intraTMP or IBC.

Referring again to FIG. 3, transform module 308 can transform the video signals in the residual block from the pixel domain to a transform domain (e.g., a frequency domain depending on the transform method). It is understood that in some examples, transform module 308 may be skipped, and the video signals may not be transformed to the transform domain.

Quantization module 310 may be configured to quantize the coefficient of each position in the coding block to generate quantization levels of the positions. The current block may be the residual block. That is, quantization module 310 can perform a quantization process on each residual block. The residual block may include N×M positions (samples), each associated with a transformed or non-transformed video signal/data, such as luma and/or chroma information, where N and M are positive integers. In the present disclosure, before quantization, the transformed or non-transformed video signal at a specific position is referred to herein as a “coefficient.” After quantization, the quantized value of the coefficient is referred to herein as a “quantization level” or “level.”

Quantization can be used to reduce the dynamic range of transformed or non-transformed video signals so that fewer bits will be used to represent video signals. Quantization typically involves division by a quantization step size and subsequent rounding, while dequantization (a.k.a. inverse quantization) involves multiplication by the quantization step size. The quantization step size can be indicated by a quantization parameter (QP). Such a quantization process is referred to as scalar quantization. The quantization of all coefficients within a coding block can be done independently, and this kind of quantization method is used in some existing video compression standards, such as H.264/AVC and H.265/HEVC. The QP in quantization can affect the bit rate used for encoding/decoding the pictures of the video. For example, a higher QP can result in a lower bit rate, and a lower QP can result in a higher bit rate.

For an N×M coding block, a specific coding scan order may be used to convert the two-dimensional (2D) coefficients of a block into a one-dimensional (1D) order for coefficient quantization and coding. Typically, the coding scan starts from the left-top corner and stops at the right-bottom corner of a coding block or the last non-zero coefficient/level in a right-bottom direction. It is understood that the coding scan order may include any suitable order, such as a zig-zag scan order, a vertical (column) scan order, a horizontal (row) scan order, a diagonal scan order, or any combinations thereof. Quantization of a coefficient within a coding block may make use of the coding scan order information. For example, it may depend on the status of the previous quantization level along the coding scan order. In order to further improve the coding efficiency, more than one quantizer, e.g., two scalar quantizers, can be used by quantization module 310. Which quantizer will be used for quantizing the current coefficient may depend on the information preceding the current coefficient in coding scan order. Such a quantization process is referred to as dependent quantization.

Referring to FIG. 3, encoding module 320 may be configured to encode the quantization level of each position in the coding block into the bitstream. In some embodiments, encoding module 320 may perform entropy encoding on the coding block. Entropy encoding may use various binarization methods, such as Golomb-Rice binarization, to convert each quantization level into a respective binary representation, such as binary bins. Then, the binary representation can be further compressed using entropy encoding algorithms. The compressed data may be added to the bitstream. Besides the quantization levels, encoding module 320 may encode various other information, such as block type information of a coding unit, prediction mode information, partitioning unit information, prediction unit information, transmission unit information, motion vector information, reference frame information, block interpolation information, and filtering information input from, for example, prediction modules 304 and 306. In some embodiments, encoding module 320 may perform residual coding on a coding block to convert the quantization level into the bitstream. For example, after quantization, there may be N×M quantization levels for an N×M block. These N×M levels may be zero or non-zero values. The non-zero levels may be further binarized to binary bins if the levels are not binary, for example, using combined Truncated Rice (TR) and limited EGk binarization.

Non-binary syntax elements may be mapped to binary codewords. The bijective mapping between symbols and codewords, for which typically simple structured codes are used, is called binarization. The binary symbols, also called bins, of both binary syntax elements and codewords for non-binary data may be coded using binary arithmetic coding. The core coding engine of context-adaptive binary arithmetic coding (CABAC) can support two operating modes: a context coding mode, in which the bins are coded with adaptive probability models, and a less complex bypass mode that uses a fixed probability of ½. The adaptive probability models are also called contexts, and the assignment of probability models to individual bins is referred to as context modeling.

As shown in FIG. 3, dequantization module 312 may be configured to dequantize the quantization levels by dequantization module 312, and inverse transform module 314 may be configured to inversely transform the coefficients transformed by transform module 308. The reconstructed residual block generated by dequantization module 312 and inverse transform module 314 may be combined with the prediction units predicted through prediction module 304 or 306 to generate a reconstructed block.

Filter module 316 may include at least one among a deblocking filter, a sample adaptive offset (SAO), and an adaptive loop filter (ALF). The deblocking filter may remove block distortion generated by the boundary between blocks in the reconstructed picture. The SAO module may correct an offset to the original video by the unit of pixel for a video on which the deblocking has been performed. ALF may be performed based on a value obtained by comparing the reconstructed and filtered video with the original video. Buffer module 318 may be configured to store the reconstructed block or picture calculated through filter module 316, and the reconstructed and stored block or picture may be provided to inter prediction module 304 when inter prediction is performed.

FIG. 4 illustrates a detailed block diagram of exemplary decoder 201 in decoding system 200 in FIG. 2, according to some embodiments of the present disclosure. As shown in FIG. 4, decoder 201 may include a decoding module 402, a dequantization module 404, an inverse transform module 406, an inter prediction module 408, an intra prediction module 410, a filter module 412, and a buffer module 414. It is understood that each of the elements shown in FIG. 4 is independently shown to represent characteristic functions different from each other in a video decoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on decoder 201.

When a video bitstream is input from a video encoder (e.g., encoder 101), the input bitstream may be decoded by decoder 201 in a procedure opposite to that of the video encoder. Thus, some details of decoding that are described above with respect to encoding may be skipped for ease of description. Decoding module 402 may be configured to decode the bitstream to obtain various information encoded into the bitstream, such as the quantization level of each position in the coding block. In some embodiments, decoding module 402 may perform entropy decoding (decompressing) corresponding to the entropy encoding (compressing) performed by the encoder, such as, for example, video local-area network (VideoLAN) coding (VLC), context-adaptive variable-length coding (CAVLC), CABAC, syntax-based binary arithmetic coding (SBAC), PIPE coding, and the like to obtain the binary representation (e.g., binary bins). Decoding module 402 may further convert the binary representations to quantization levels using Golomb-Rice binarization, including, for example, EGk binarization and combined TR and limited EGk binarization. Besides the quantization levels of the positions in the transform units, decoding module 402 may decode various other information, such as the parameters used for Golomb-Rice binarization (e.g., the Rice parameter), block type information of a coding unit, prediction mode information, partitioning unit information, prediction unit information, transmission unit information, motion vector information, reference frame information, block interpolation information, and filtering information. During the decoding process, decoding module 402 may perform rearrangement on the bitstream to reconstruct and rearrange the data from a 1D order into a 2D rearranged block through a method of inverse-scanning based on the coding scan order used by the encoder.

Dequantization module 404 may be configured to dequantize the quantization level of each position of the coding block (e.g., the 2D reconstructed block) to obtain the coefficient of each position. In some embodiments, dequantization module 404 may perform dependent dequantization based on quantization parameters provided by the encoder as well, including the information related to the quantizers used in dependent quantization, for example, the quantization step size used by each quantizer.

Inverse transform module 406 may be configured to perform inverse transformation, for example, inverse discrete cosine transform (DCT), inverse DST, and inverse Karhunen-Loève transform (KLT), for DCT, DST, and KLT performed by the encoder, respectively, to transform the data from the transform domain (e.g., coefficients) back to the pixel domain (e.g., luma and/or chroma information). In some embodiments, inverse transform module 406 may selectively perform a transform operation (e.g., DCT, DST, KLT) according to a plurality of pieces of information such as a prediction method, a size of the current block, a prediction direction, and the like.

Inter prediction module 408 and intra prediction module 410 may be configured to generate a prediction block based on information related to the generation of a prediction block provided by decoding module 402 and information of a previously decoded block or picture provided by buffer module 414. As described above, if the size of the prediction unit and the size of the transform unit are the same when intra prediction is performed in the same manner as the operation of the encoder, intra prediction may be performed on the prediction unit based on the pixel existing on the left side, the pixel on the top-left side, and the pixel on the top of the prediction unit. However, if the size of the prediction unit and the size of the transform unit are different when intra prediction is performed, intra prediction may be performed using a reference pixel based on a transform unit.

For example, inter prediction module 408 may be configured to receive a bitstream that includes a reference frame, a current frame, and an indication of a weighting factor associated with a multiple-hypothesis prediction (MHP) procedure from an encoder. Inter prediction module 408 may be configured to perform the MHP procedure for a CU located in the current frame based on a search block (e.g., reference frame and/or reference template) in the reference frame. In some embodiments, to perform the MHP procedure, the inter prediction module 408 may be configured to perform template matching for the CU located in the current frame based on a search block in the reference frame and the weighting factor to obtain motion information. In some embodiments, to perform the MHP procedures, inter prediction module 408 may be configured to identify a weighting factor index associated with the weighting factor based on the template matching. Inter prediction module 408 may be configured to identify a weighting factor sign of the weighting factor based on an indication included in the bitstream. Inter prediction module performs an inter prediction procedure based on the current frame, the reference frame, the weighting factor index, and the weighting factor sign of the weighting factor to decode the bitstream.

The reconstructed block or reconstructed picture combined from the outputs of inverse transform module 406 and prediction module 408 or 410 may be provided to filter module 412. Filter module 412 may include a deblocking filter, an offset correction module, and an ALF. Buffer module 414 may store the reconstructed picture or block and use it as a reference picture or a reference block for inter prediction module 408 and may output the reconstructed picture.

Consistent with the scope of the present disclosure, encoding module 320 and decoding module 402 may be configured to adopt a scheme of quantization level binarization with Rice parameter adapted to the bit depth and/or the bit rate for encoding the picture of the video to improve the coding efficiency.

As mentioned above, with a dual tree partition, a chroma block may be coded as BVG-CCCM or DBV mode when the corresponding luma is coded as either intraTMP or IBC. However, the prediction only generated with BVG-CCCM or DBV may not be optimal because the prediction block generated by BVG-CCCM or DBV may not capture all the available information. In addition, BVG-CCCM may not be allowed at a single tree partition and the coding performance for coding a chroma block could be further improved.

To overcome these challenges of other techniques, the present disclosure proposes that the BVG-CCCM chroma prediction may be fused with a reference chroma block, ref_chroma, pointed at by a chroma BV to form the final prediction for the current chroma block when the corresponding luma block is coded as either intraTMP or IBC. The present disclosure refers to this prediction as a “fused BVG-CCCM (FBVG-CCCM) prediction.”

Still referring to FIG. 4, to overcome these and other challenges, the present disclosure proposes intra prediction module 410 configured to perform FBVG-CCCM prediction.

For an intraTMP or IBC coded luma block, a reference luma block, ref_luma, is indicated by a block vector bvL. Similarly, a corresponding reference chroma block, ref_chroma, is indicated by a block vector bvC, where bvC is a scaled version of bvL depending on the chroma format of the video sequence. For example, when the chroma format is 4:2:0, bvC may be obtained by 0.5*bvL. When the chroma format is 4:4:4, bvC may be equal to bvL. When the chroma format is 4:2:2, the horizontal component of bvC may be obtained by scaling the horizontal component of bvL by 0.5 and the vertical component of bvC may be set equal to the vertical component of bvL.

Intra prediction module 410 may determine whether the FBVG-CCCM mode is eligible based on an eligibility condition, depending on the partitioning structure of the current slice. For a single tree partitioning, if the co-located luma block of the current chroma block is coded as either intraTMP or IBC, intra prediction module 410 may determine the FBVG-CCCM mode is eligible. For a dual tree partitioning, co-located luma block areas shown in FIG. 12 are scanned, and if at least one of these areas is coded as either IBC or intraTMP, intra prediction module 410 may determine FBVG-CCCM is eligible.

If FBVG-CCCM is selected for the current chroma block, the prediction of FBVG-CCCM, pred_{FBVG-CCCM} is a fusion of the BVG-CCCM prediction, pred_{BVG-CCCM}, and intra prediction module 410 may calculate the reference chroma, pred_{ref}_{_{chroma}}, according to equation (5).

$${pred}_{FBVG - CCCM} = {w}_{0} * {pred}_{BVG - CCCM} + {w}_{1} * {pred}_{{ref}_{chroma}} , \qquad ( 5 )$$

where w₀ and w₁ are two weighting factors. In some implementations, the weighting factors w₀ and w₁ may be fixed weighting factors. For example, they may be set as ¾ and ¼, respectively, or any other two positive numbers with a sum equal to 1.

When the FBVG-CCCM mode is eligible, intra prediction module 410 may determine whether FBVG-CCCM is selected in several different ways, as described below.

In some implementations, an FBVG-CCCM flag may be signaled in either single or dual tree partitioning when the CCCM flag is true, and FBVG-CCCM has been determined eligible. If the FBVG-CCCM flag is equal to 1, intra prediction module 410 may use FBVG-CCCM to generate the prediction for the current chroma block. If the FBVG-CCCM flag is equal to 0, intra prediction module 410 may use regular CCCM to generate the prediction for current chroma block. In this arrangement, FBVG-CCCM is signaled conditionally after CCCM (e.g., it may be considered a sub-mode of CCCM).

In some implementations, with a dual tree partition, an FBVG-CCCM flag may be signaled if the DBV flag is true, which also satisfies the eligibility condition for FBVG-CCCM. If the FBVG-CCCM flag is equal to 1, intra prediction module 410 may use FBVG-CCCM to generate the prediction for the current chroma block. If the FBVG-CCCM flag is equal to 0, intra prediction module 410 may use the existing DBV mode to generate the prediction for the current chroma block. In single tree partitioning, if DBV or a DBV-like mode is signaled FBVG-CCCM may also be allowed if the DBV flag is true. For example, if DM mode is signaled but the chroma prediction mode is interpreted as the DBV method because the co-located luma prediction mode was IBC, then the FBVG-CCCM flag may be signaled if the DM flag is equal to 1. If the FBVG-CCCM flag is equal to 1, intra prediction module 410 may use FBVG-CCCM to generate the prediction for the current chroma block. If the FBVG-CCCM flag is equal to 0, intra prediction module 410 may use the DBV mode to generate the prediction for the current chroma block. In this arrangement FBVG-CCCM is signaled conditionally after DBV (i.e., it may be considered a sub-mode of DBV).

In another arrangement, when FBVG-CCCM has been determined eligible, an FBVG-CCCM flag may be signaled first. If FBVG-CCCM is equal to 1, intra prediction module 410 may use FBVG-CCCM to generate the prediction for the current chroma block. If the FBVG-CCCM flag is not signaled (e.g., implicitly set to 0), or is equal to 0, a second flag may be signaled. If the second flag is equal to 1, intra prediction module 410 may use DBV mode to generate the prediction for the current chroma block. If the second flag is equal to 0, intra prediction module 410 may use CCCM to generate the prediction for the current chroma block.

The FBVG-CCCM method may be signaled if corresponding luma_cbf syntax element is non-zero.

The above arrangement describe control of the FBVG-CCCM mode at CU level with CU-level signaling. Additionally and/or alternatively, the FBVG-CCCM mode may be enabled jointly or separately at different levels, e.g., sequence parameter set (SPS), picture header (PH), picture parameter set (PPS), and slice header (SH) levels.

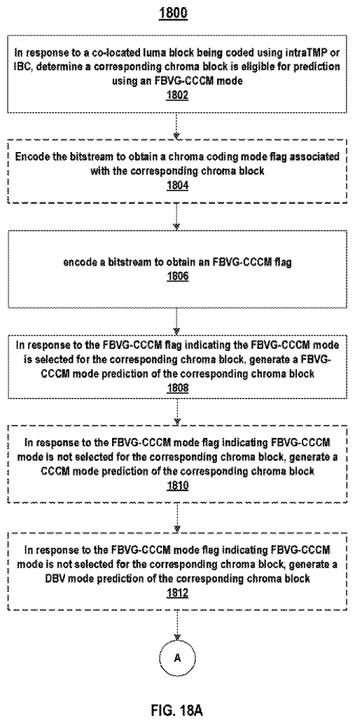

FIGS. 17A and 17B illustrate a flowchart of a method 1700 of decoding, according to some embodiments of the present disclosure. Method 1700 may be performed by a system, e.g., such as decoding system 200, decoder 201, or intra prediction module 410, just to name a few. Method 1700 may include operations 1702-1718, as described below. It is to be appreciated that some of the steps may be optional, and some of the steps may be performed simultaneously, or in a different order than shown in FIGS. 17A and 17B.

Referring to FIG. 17A, at 1702, the system may, in response to a co-located luma block being coded using intraTMP or IBC, determine a corresponding chroma block is eligible for prediction using an FBVG-CCCM mode. For example, referring to FIG. 4, intra prediction module 410 may determine whether the FBVG-CCCM mode is eligible based on an eligibility condition, depending on the partitioning structure of the current slice. For a single tree partitioning, if the co-located luma block of the current chroma block is coded as either intraTMP or IBC, intra prediction module 410 may determine the FBVG-CCCM mode is eligible. For a dual tree partitioning, co-located luma block areas shown in FIG. 12 are scanned, and if at least one of these areas is coded as either IBC or intraTMP, intra prediction module 410 may determine FBVG-CCCM is eligible.

At 1704, the system may parse the bitstream to obtain a chroma coding mode flag associated with the corresponding chroma block. For example, referring to FIG. 4, intra prediction module 410 may parse a bitstream to obtain a chroma coding mode flag. The chroma coding mode flag may be a DM flag, a DBV flag, or a CCCM flag. In some implementations, the intra prediction module 410 may obtain the chroma coding mode flag prior to obtaining the FBVG-CCCM flag.

At 1706, the system may parse a bitstream to obtain an FBVG-CCCM flag. For example, referring to FIG. 4, intra prediction module 410 may parse the bitstream to obtain a FBVG-CCCM flag. In some implementations, the FBVG-CCCM flag may be decoded from the bitstream when the chroma coding mode flag indicates the current chroma block is eligible for FBVG-CCCM. In some other implementations, the FBVG-CCCM flag may be decoded prior to the chroma coding mode flag.

At 1708, the system may, in response to the FBVG-CCCM flag indicating the FBVG-CCCM mode is selected for the corresponding chroma block, generate a FBVG-CCCM mode prediction of the corresponding chroma block. In some implementations, the generating, by the processor, the FBVG-CCCM mode prediction of the corresponding chroma block may include obtaining, by the processor, a reference chroma block pointed to by a block vector (BV) of the corresponding chroma block (bvC). In some implementations, the generating, by the processor, the FBVG-CCCM mode prediction of the corresponding chroma block may include generating, by the processor, a BVG-CCCM prediction of the corresponding chroma block. In some implementations, the generating, by the processor, the FBVG-CCCM mode prediction of the corresponding chroma block may include multiplying, by the processor, the reference chroma block with a first weighting factor. In some implementations, the generating, by the processor, the FBVG-CCCM mode prediction of the corresponding chroma block may include multiplying, by the processor, the BVG-CCCM prediction of the corresponding chroma block by a second weighting factor. In some implementations, the generating, by the processor, the FBVG-CCCM mode prediction of the corresponding chroma block may include summing, by the processor, the reference chroma block multiplied by the first weighting factor and the BVG-CCCM prediction of the corresponding chroma block multiplied by the second weighting factor to generate the FBVG-CCCM mode prediction of the corresponding chroma block. For example, referring to FIG. 4, if FBVG-CCCM is selected for the current chroma block, the prediction of FBVG-CCCM, pred_{FBVG-CCCM} is a fusion of the BVG-CCCM prediction, pred_{BVG-CCCM}, and intra prediction module 410 may calculate the reference chroma, pred_{ref}_{_{chroma}}, according to equation (5). When the FBVG-CCCM flag is 1, intra prediction module 410 may determine FBVG-CCCM prediction is selected for the current chroma block.

At 1710, the system may, in response to the FBVG-CCCM flag indicating FBVG-CCCM mode is not selected for the corresponding chroma block, generate a CCCM mode prediction of the corresponding chroma block. For example, referring to FIG. 4, if the FBVG-CCCM flag is equal to 0, intra prediction module 410 may use regular CCCM to generate the prediction for current chroma block. In this arrangement, FBVG-CCCM is signaled conditionally after CCCM (e.g., it may be considered a sub-mode of CCCM).

At 1712, the system may, in response to the FBVG-CCCM flag indicating FBVG-CCCM mode is not selected for the corresponding chroma block, generate a DBV mode prediction of the corresponding chroma block. For example, referring to FIG. 4, if the FBVG-CCCM flag is equal to 0, intra prediction module 410 may use the DBV mode to generate the prediction for the current chroma block. In this arrangement, FBVG-CCCM is signaled conditionally after DBV (i.e., it may be considered a sub-mode of DBV).

Referring to FIG. 17B, at 1714, the system may, in response to the FBVG-CCCM flag indicating the FBVG-CCCM mode is not selected for the corresponding chroma block, parse the bitstream to obtain a chroma coding mode flag for the corresponding chroma block. For example, referring to FIG. 4, in another arrangement, when FBVG-CCCM has been determined eligible, an FBVG-CCCM flag may be signaled before the chroma coding mode flag. If the FBVG-CCCM flag is not signaled (e.g., implicitly set to 0), or is equal to 0, the chroma coding mode flag may be signaled.

At 1716, the system may, in response to the chroma coding mode flag having a first value, generate a CCCM mode prediction of the corresponding chroma block. For example, referring to FIG. 4, in another arrangement, when FBVG-CCCM has been determined eligible, an FBVG-CCCM flag may be signaled before the chroma coding mode flag. If the FBVG-CCCM flag is not signaled (e.g., implicitly set to 0), or is equal to 0, the chroma coding mode flag may be signaled. If the second flag is equal to 0, intra prediction module 410 may use CCCM to generate the prediction for the current chroma block.

At 1718, the system may, in response to the chroma coding mode flag having a second value, generate DBV mode prediction of the corresponding chroma block. For example, referring to FIG. 4, in another arrangement, when FBVG-CCCM has been determined eligible, an FBVG-CCCM flag may be signaled before the chroma coding mode flag. If the FBVG-CCCM flag is not signaled (e.g., implicitly set to 0), or is equal to 0, the chroma coding mode flag may be signaled. If the second flag is equal to 1, intra prediction module 410 may use DBV mode to generate the prediction for the current chroma block.

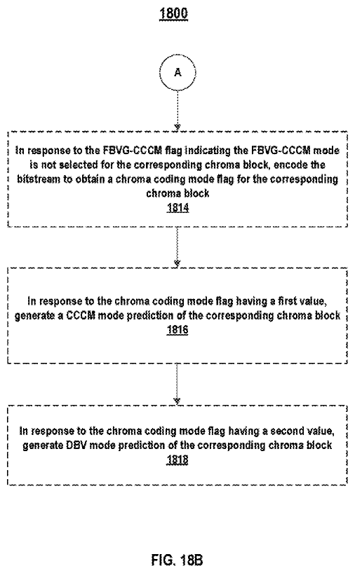

FIGS. 18A and 18B illustrate a flowchart of a method of encoding 1800, according to some embodiments of the present disclosure. Method 1800 may be performed by a system, e.g., such as encoding system 100, encoder 101, or intra prediction module 306, just to name a few. Method 1800 may include operations 1802-1818, as described below. It is to be appreciated that some of the steps may be optional, and some of the steps may be performed simultaneously, or in a different order than shown in FIGS. 18A and 18B.

Referring to FIG. 18A, at 1802, the system may, in response to a co-located luma block being coded using intraTMP or IBC, determine a corresponding chroma block is eligible for prediction using an FBVG-CCCM mode. For example, referring to FIG. 3, intra prediction module 306 may determine whether the FBVG-CCCM mode is eligible based on an eligibility condition, depending on the partitioning structure of the current slice. For a single tree partitioning, if the co-located luma block of the current chroma block is coded as either intraTMP or IBC, intra prediction module 306 may determine the FBVG-CCCM mode is eligible. For a dual tree partitioning, co-located luma block areas shown in FIG. 12 are scanned, and if at least one of these areas is coded as either IBC or intraTMP, intra prediction module 306 may determine FBVG-CCCM is eligible.

At 1804, the system may encode a chroma coding mode flag associated with the corresponding chroma block. For example, referring to FIG. 3, intra prediction module 306 may encode a chroma coding mode flag for the current chroma block. The chroma coding mode flag may be a DM flag, a DBV flag, or a CCCM flag. In some implementations, the intra prediction module 306 may encode the chroma coding mode flag prior to obtaining the FBVG-CCCM flag.

At 1806, the system may encode an FBVG-CCCM flag. For example, referring to FIG. 3, intra prediction module 306 may encode a FBVG-CCCM flag to indicate whether FBVG-CCCM is selected for the current chroma block. In some implementations, the FBVG-CCCM flag may be encoded when the chroma coding mode flag indicates the current chroma block is eligible for FBVG-CCCM. In some other implementations, the FBVG-CCCM flag may be encoded prior to the chroma coding mode flag.

At 1808, the system may, in response to the FBVG-CCCM flag indicating the FBVG-CCCM mode is selected for the corresponding chroma block, generate a FBVG-CCCM mode prediction of the corresponding chroma block. In some implementations, the generating, by the processor, the FBVG-CCCM mode prediction of the corresponding chroma block may include obtaining, by the processor, a reference chroma block pointed to by a block vector (BV) of the corresponding chroma block (bvC). In some implementations, the generating, by the processor, the FBVG-CCCM mode prediction of the corresponding chroma block may include generating, by the processor, a BVG-CCCM prediction of the corresponding chroma block. In some implementations, the generating, by the processor, the FBVG-CCCM mode prediction of the corresponding chroma block may include multiplying, by the processor, the reference chroma block with a first weighting factor. In some implementations, the generating, by the processor, the FBVG-CCCM mode prediction of the corresponding chroma block may include multiplying, by the processor, the BVG-CCCM prediction of the corresponding chroma block by a second weighting factor. In some implementations, the generating, by the processor, the FBVG-CCCM mode prediction of the corresponding chroma block may include summing, by the processor, the reference chroma block multiplied by the first weighting factor and the BVG-CCCM prediction of the corresponding chroma block multiplied by the second weighting factor to generate the FBVG-CCCM mode prediction of the corresponding chroma block. For example, referring to FIG. 3, if FBVG-CCCM is selected for the current chroma block, the prediction of FBVG-CCCM, pred_{FBVG-CCCM} is a fusion of the BVG-CCCM prediction, pred_{BVG-CCCM}, and intra prediction module 306 may calculate the reference chroma, pred_{ref}_{_{chroma}}, according to equation (5). When the FBVG-CCCM flag is 1, intra prediction module 306 may determine FBVG-CCCM prediction is selected for the current chroma block.

At 1810, the system may, in response to the FBVG-CCCM flag indicating FBVG-CCCM mode is not selected for the corresponding chroma block, generate a CCCM mode prediction of the corresponding chroma block. For example, referring to FIG. 3, if the FBVG-CCCM flag is equal to 0, intra prediction module 306 may use regular CCCM to generate the prediction for current chroma block. In this arrangement, FBVG-CCCM is signaled conditionally after CCCM (e.g., it may be considered a sub-mode of CCCM).

At 1812, the system may, in response to the FBVG-CCCM flag indicating FBVG-CCCM mode is not selected for the corresponding chroma block, generate a DBV mode prediction of the corresponding chroma block. For example, referring to FIG. 3, if the FBVG-CCCM flag is equal to 0, intra prediction module 306 may use the DBV mode to generate the prediction for the current chroma block. In this arrangement FBVG-CCCM is signaled conditionally after DBV (i.e., it may be considered a sub-mode of DBV).

Referring to FIG. 18B, at 1814, the system may, in response to the FBVG-CCCM flag indicating the FBVG-CCCM mode is not selected for the corresponding chroma block, encode a chroma coding mode flag for the corresponding chroma block. For example, referring to FIG. 3, in another arrangement, when FBVG-CCCM has been determined eligible, intra prediction module 306 may encode an FBVG-CCCM flag before the chroma coding mode flag. If the FBVG-CCCM flag is not signaled (e.g., implicitly set to 0), or is equal to 0, the chroma coding mode flag may be signaled.

At 1816, the system may, in response to the chroma coding mode flag having a first value, generate a CCCM mode prediction of the corresponding chroma block. For example, referring to FIG. 3, in another arrangement, when FBVG-CCCM has been determined eligible, an FBVG-CCCM flag may be signaled before the chroma coding mode flag. If the FBVG-CCCM flag is not signaled (e.g., implicitly set to 0), or is equal to 0, the chroma coding mode flag may be signaled. If the second flag is equal to 0, intra prediction module 306 may use CCCM to generate the prediction for the current chroma block.

At 1818, the system may, in response to the chroma coding mode flag having a second value, generate DBV mode prediction of the corresponding chroma block. For example, referring to FIG. 3, in another arrangement, when FBVG-CCCM has been determined eligible, an FBVG-CCCM flag may be signaled before the chroma coding mode flag. If the FBVG-CCCM flag is not signaled (e.g., implicitly set to 0), or is equal to 0, the chroma coding mode flag may be signaled. If the second flag is equal to 1, intra prediction module 306 may use DBV mode to generate the prediction for the current chroma block.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, include CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of decoding by a decoder is provided. The method may include, in response to a co-located luma block being coded using intra template matching (intraTMP) or intra block copy (IBC), determining, by a processor, a corresponding chroma block is eligible for prediction using a fused block vector guided (FBVG)-convolutional cross-component intra prediction model (CCCM) (FBVG-CCCM) mode. The method may include parsing, by the processor, a bitstream to obtain an FBVG-CCCM flag. The method may include, in response to the FBVG-CCCM flag indicating the FBVG-CCCM mode is selected for the corresponding chroma block, generating, by the processor, a FBVG-CCCM mode prediction of the corresponding chroma block.

In some implementations, the generating, by the processor, the FBVG-CCCM mode prediction of the corresponding chroma block may include obtaining, by the processor, a reference chroma block pointed to by a block vector (BV) of the corresponding chroma block (bvC). In some implementations, the generating, by the processor, the FBVG-CCCM mode prediction of the corresponding chroma block may include generating, by the processor, a BVG-CCCM prediction of the corresponding chroma block. In some implementations, the generating, by the processor, the FBVG-CCCM mode prediction of the corresponding chroma block may include multiplying, by the processor, the reference chroma block with a first weighting factor. In some implementations, the generating, by the processor, the FBVG-CCCM mode prediction of the corresponding chroma block may include multiplying, by the processor, the BVG-CCCM prediction of the corresponding chroma block by a second weighting factor. In some implementations, the generating, by the processor, the FBVG-CCCM mode prediction of the corresponding chroma block may include summing, by the processor, the reference chroma block multiplied by the first weighting factor and the BVG-CCCM prediction of the corresponding chroma block multiplied by the second weighting factor to generate the FBVG-CCCM mode prediction of the corresponding chroma block.

In some implementations, the method may include parsing, by the processor, the bitstream to obtain a chroma coding mode flag associated with the corresponding chroma block. In some implementations, the bitstream may be parsed to obtain the FBVG-CCCM flag in response to the chroma coding mode flag indicating one of a DM, a DBV mode, or a CCCM mode for the corresponding chroma block.

In some implementations, the method may include, in response to the FBVG-CCCM flag indicating FBVG-CCCM mode is not selected for the corresponding chroma block, generating, by the processor, a CCCM mode prediction of the corresponding chroma block.

In some implementations, the method may include, in response to the FBVG-CCCM flag indicating FBVG-CCCM mode is not selected for the corresponding chroma block, generating, by the processor, a DBV mode prediction of the corresponding chroma block.

In some implementations, the method may include, in response to the FBVG-CCCM flag indicating the FBVG-CCCM mode is not selected for the corresponding chroma block, parsing, by the processor, the bitstream to obtain a chroma coding mode flag for the corresponding chroma block. In some implementations, the method may include, in response to the chroma coding mode flag having a first value, generating, by the processor, a CCCM mode prediction of the corresponding chroma block. In some implementations, the method may include, in response to the chroma coding mode flag having a second value, generating, by the processor, a DBV mode prediction of the corresponding chroma block.

In some implementations, the FBVG-CCCM flag may be signaled when a cbf_luma syntax element is non-zero.

In some implementations, the FBVG-CCCM mode is enabled at one or more of an SPS level, a PH level, a PPS level, or an SH level.

According to another aspect of the present disclosure, a decoder is provided. The decoder may include a processor and memory storing instructions. The memory storing instructions, which when executed by the processor, may cause the processor to, in response to a co-located luma block being coded using intraTMP or IBC, determine a corresponding chroma block is eligible for prediction using an FBVG-CCCM mode. The memory storing instructions, which when executed by the processor, may cause the processor to parse a bitstream to obtain an FBVG-CCCM flag. The memory storing instructions, which when executed by the processor, may cause the processor to, in response to the FBVG-CCCM flag indicating the FBVG-CCCM mode is selected for the corresponding chroma block, generate a FBVG-CCCM mode prediction of the corresponding chroma block.

In some implementations, to generate the FBVG-CCCM mode prediction of the corresponding chroma block, the memory storing instructions, which when executed by the processor, may cause the processor to obtain a reference chroma block pointed to by a block vector (BV) of the corresponding chroma block (bvC). In some implementations, to generate the FBVG-CCCM mode prediction of the corresponding chroma block, the memory storing instructions, which when executed by the processor, may cause the processor to generate a BVG-CCCM prediction of the corresponding chroma block. In some implementations, to generate the FBVG-CCCM mode prediction of the corresponding chroma block, the memory storing instructions, which when executed by the processor, may cause the processor to multiply the reference chroma block with a first weighting factor. In some implementations, to generate the FBVG-CCCM mode prediction of the corresponding chroma block, the memory storing instructions, which when executed by the processor, may cause the processor to multiply the BVG-CCCM prediction of the corresponding chroma block by a second weighting factor. In some implementations, to generate the FBVG-CCCM mode prediction of the corresponding chroma block, the memory storing instructions, which when executed by the processor, may cause the processor to sum the reference chroma block multiplied by the first weighting factor and the BVG-CCCM prediction of the corresponding chroma block multiplied by the second weighting factor to generate the FBVG-CCCM mode prediction of the corresponding chroma block.

In some implementations, the memory storing instructions, which when executed by the processor, may further cause the processor to parse the bitstream to obtain a chroma coding mode flag associated with the corresponding chroma block. In some implementations, the bitstream may be parsed to obtain the FBVG-CCCM flag in response to the chroma coding mode flag indicating one of a DM, a DBV mode, or a CCCM mode for the corresponding chroma block.

In some implementations, the memory storing instructions, which when executed by the processor, may further cause the processor to, in response to the FBVG-CCCM flag indicating FBVG-CCCM mode is not selected for the corresponding chroma block, generate a CCCM mode prediction of the corresponding chroma block.

In some implementations, the memory storing instructions, which when executed by the processor, may further cause the processor to, in response to the FBVG-CCCM flag indicating FBVG-CCCM mode is not selected for the corresponding chroma block, generate a DBV mode prediction of the corresponding chroma block.

In some implementations, the memory storing instructions, which when executed by the processor, may further cause the processor to, in response to the FBVG-CCCM flag indicating the FBVG-CCCM mode is not selected for the corresponding chroma block, parse the bitstream to obtain a chroma coding mode flag for the corresponding chroma block. In some implementations, the memory storing instructions, which when executed by the processor, may further cause the processor to, in response to the chroma coding mode flag having a first value, generate a CCCM mode prediction of the corresponding chroma block. In some implementations, the memory storing instructions, which when executed by the processor, may further cause the processor to, in response to the chroma coding mode flag having a second value, generate a DBV mode prediction of the corresponding chroma block.

In some implementations, the FBVG-CCCM flag may be signaled when a cbf_luma syntax element is non-zero.

In some implementations, the FBVG-CCCM mode may be enabled at one or more of an SPS level, a PH level, a PPS level, or an SH level.

According to a further aspect of the present disclosure, an apparatus for decoding is provided. The apparatus for decoding may include a processor and memory storing instructions. The memory storing instructions, which when executed by the processor, may cause the processor to, in response to a co-located luma block being coded using intraTMP or IBC, determine a corresponding chroma block is eligible for prediction using an FBVG-CCCM mode. The memory storing instructions, which when executed by the processor, may cause the processor to parse a bitstream to obtain an FBVG-CCCM flag. The memory storing instructions, which when executed by the processor, may cause the processor to, in response to the FBVG-CCCM flag indicating the FBVG-CCCM mode is selected for the corresponding chroma block, generate a FBVG-CCCM mode prediction of the corresponding chroma block.

According to yet another aspect of the present disclosure, a non-transitory computer-readable medium storing instructions for a decoder is provided. The decoder may include a processor and memory storing instructions. The instructions, which when executed by the processor of the decoder, may cause the processor of the decoder to, in response to a co-located luma block being coded using intraTMP or IBC, determine a corresponding chroma block is eligible for prediction using an FBVG-CCCM mode. The instructions, which when executed by the processor of the decoder, may cause the processor of the decoder to parse a bitstream to obtain an FBVG-CCCM flag. The instructions, which when executed by the processor of the decoder, may cause the processor of the decoder to, in response to the FBVG-CCCM flag indicating the FBVG-CCCM mode is selected for the corresponding chroma block, generate a FBVG-CCCM mode prediction of the corresponding chroma block.

In some implementations, to generate the FBVG-CCCM mode prediction of the corresponding chroma block, the instructions, which when executed by the processor of the decoder, may cause the processor of the decoder to obtain a reference chroma block pointed to by a block vector (BV) of the corresponding chroma block (bvC). In some implementations, to generate the FBVG-CCCM mode prediction of the corresponding chroma block, the instructions, which when executed by the processor of the decoder, may cause the processor of the decoder to generate a BVG-CCCM prediction of the corresponding chroma block. In some implementations, to generate the FBVG-CCCM mode prediction of the corresponding chroma block, the instructions, which when executed by the processor of the decoder, may cause the processor of the decoder to multiply the reference chroma block with a first weighting factor. In some implementations, to generate the FBVG-CCCM mode prediction of the corresponding chroma block, the instructions, which when executed by the processor of the decoder, may cause the processor of the decoder to multiply the BVG-CCCM prediction of the corresponding chroma block by a second weighting factor. In some implementations, to generate the FBVG-CCCM mode prediction of the corresponding chroma block, the instructions, which when executed by the processor of the decoder, may cause the processor of the decoder to sum the reference chroma block multiplied by the first weighting factor and the BVG-CCCM prediction of the corresponding chroma block multiplied by the second weighting factor to generate the FBVG-CCCM mode prediction of the corresponding chroma block.

In some implementations, the instructions, which when executed by the processor of the decoder, may further cause the processor of the decoder to parse the bitstream to obtain a chroma coding mode flag associated with the corresponding chroma block. In some implementations, the bitstream may be parsed to obtain the FBVG-CCCM flag in response to the chroma coding mode flag indicating one of a DM, a DBV mode, or a CCCM mode for the corresponding chroma block.

In some implementations, the instructions, which when executed by the processor of the decoder, may further cause the processor of the decoder to, in response to the FBVG-CCCM flag indicating FBVG-CCCM mode is not selected for the corresponding chroma block, generate a CCCM mode prediction of the corresponding chroma block.

In some implementations, the instructions, which when executed by the processor of the decoder, may further cause the processor of the decoder to, in response to the FBVG-CCCM flag indicating FBVG-CCCM mode is not selected for the corresponding chroma block, generate a DBV mode prediction of the corresponding chroma block.

In some implementations, the instructions, which when executed by the processor of the decoder, may further cause the processor of the decoder to, in response to the FBVG-CCCM flag indicating the FBVG-CCCM mode is not selected for the corresponding chroma block, parse the bitstream to obtain a chroma coding mode flag for the corresponding chroma block. In some implementations, the instructions, which when executed by the processor of the decoder, may further cause the processor of the decoder to, in response to the chroma coding mode flag having a first value, generate a CCCM mode prediction of the corresponding chroma block. In some implementations, the instructions, which when executed by the processor of the decoder, may further cause the processor of the decoder to, in response to the chroma coding mode flag having a second value, generate a DBV mode prediction of the corresponding chroma block.

In some implementations, the FBVG-CCCM flag may be signaled when a cbf_luma syntax element is non-zero.

In some implementations, the FBVG-CCCM mode may be enabled at one or more of an SPS level, a PH level, a PPS level, or an SH level.

According to yet a further aspect of the present disclosure, a method of encoding by an encoder is provided. The method may include, in response to a co-located luma block being coded using intraTMP or IBC, determining, by a processor, a corresponding chroma block is eligible for prediction using an FBVG-CCCM mode. The method may include encoding, by the processor, an FBVG-CCCM flag. The method may include, in response to the FBVG-CCCM flag indicating the FBVG-CCCM mode is selected for the corresponding chroma block, generating, by the processor, a FBVG-CCCM mode prediction of the corresponding chroma block.

In some implementations, the generating, by the processor, the FBVG-CCCM mode prediction of the corresponding chroma block may include obtaining, by the processor, a reference chroma block pointed to by a block vector (BV) of the corresponding chroma block (bvC). In some implementations, the generating, by the processor, the FBVG-CCCM mode prediction of the corresponding chroma block may include generating, by the processor, a BVG-CCCM prediction of the corresponding chroma block. In some implementations, the generating, by the processor, the FBVG-CCCM mode prediction of the corresponding chroma block may include multiplying, by the processor, the reference chroma block with a first weighting factor. In some implementations, the generating, by the processor, the FBVG-CCCM mode prediction of the corresponding chroma block may include multiplying, by the processor, the BVG-CCCM prediction of the corresponding chroma block by a second weighting factor. In some implementations, the generating, by the processor, the FBVG-CCCM mode prediction of the corresponding chroma block may include summing, by the processor, the reference chroma block multiplied by the first weighting factor and the BVG-CCCM prediction of the corresponding chroma block multiplied by the second weighting factor to generate the FBVG-CCCM mode prediction of the corresponding chroma block.

In some implementations, the method may include encoding, by the processor, a chroma coding mode flag associated with the corresponding chroma block. In some implementations, the FBVG-CCCM flag may be encoded in response to the chroma coding mode flag indicating one of a DM, a DBV mode, or a CCCM mode for the corresponding chroma block.

In some implementations, the method may include, in response to the FBVG-CCCM flag indicating FBVG-CCCM mode is not selected for the corresponding chroma block, generating, by the processor, a CCCM mode prediction of the corresponding chroma block.

In some implementations, the method may include, in response to the FBVG-CCCM flag indicating FBVG-CCCM mode is not selected for the corresponding chroma block, generating, by the processor, a DBV mode prediction of the corresponding chroma block.

In some implementations, the method may include, in response to the FBVG-CCCM flag indicating the FBVG-CCCM mode is not selected for the corresponding chroma block, encoding, by the processor, a chroma coding mode flag for the corresponding chroma block. In some implementations, the method may include, in response to the chroma coding mode flag having a first value, generating, by the processor, a CCCM mode prediction of the corresponding chroma block. In some implementations, the method may include, in response to the chroma coding mode flag having a second value, generating, by the processor, a DBV mode prediction of the corresponding chroma block.

In some implementations, the FBVG-CCCM flag may be signaled when a cbf_luma syntax element is non-zero.

In some implementations, the FBVG-CCCM mode may be enabled at one or more of an SPS level, a PH level, a PPS level, or an SH level.

According to still another aspect of the present disclosure, an encoder is provided. The encoder may include a processor and memory storing instructions. The memory storing instructions, which when executed by the processor, may cause the processor to, in response to a co-located luma block being coded using intraTMP or IBC, determine a corresponding chroma block is eligible for prediction using a FBVG-CCCM mode. The memory storing instructions, which when executed by the processor, may cause the processor to encode an FBVG-CCCM flag. The memory storing instructions, which when executed by the processor, may cause the processor to, in response to the FBVG-CCCM flag indicating the FBVG-CCCM mode is selected for the corresponding chroma block, generate a FBVG-CCCM mode prediction of the corresponding chroma block.

In some implementations, to generate the FBVG-CCCM mode prediction of the corresponding chroma block, the memory storing instructions, which when executed by the processor, cause the processor to obtain a reference chroma block pointed to by a block vector (BV) of the corresponding chroma block (bvC). In some implementations, to generate the FBVG-CCCM mode prediction of the corresponding chroma block, the memory storing instructions, which when executed by the processor, cause the processor to generate a BVG-CCCM prediction of the corresponding chroma block. In some implementations, to generate the FBVG-CCCM mode prediction of the corresponding chroma block, the memory storing instructions, which when executed by the processor, cause the processor to multiply the reference chroma block with a first weighting factor. In some implementations, to generate the FBVG-CCCM mode prediction of the corresponding chroma block, the memory storing instructions, which when executed by the processor, cause the processor to multiply the BVG-CCCM prediction of the corresponding chroma block by a second weighting factor. In some implementations, to generate the FBVG-CCCM mode prediction of the corresponding chroma block, the memory storing instructions, which when executed by the processor, cause the processor to sum the reference chroma block multiplied by the first weighting factor and the BVG-CCCM prediction of the corresponding chroma block multiplied by the second weighting factor to generate the FBVG-CCCM mode prediction of the corresponding chroma block.

In some implementations, the memory storing instructions, which when executed by the processor, may further cause the processor to encode a chroma coding mode flag associated with the corresponding chroma block. In some implementations, the FBVG-CCCM flag may be encoded in response to the chroma coding mode flag indicating one of a DM, a DBV mode, or a CCCM mode for the corresponding chroma block.

In some implementations, the memory storing instructions, which when executed by the processor, may further cause the processor to, in response to the FBVG-CCCM flag indicating FBVG-CCCM mode is not selected for the corresponding chroma block, generate a CCCM mode prediction of the corresponding chroma block.

In some implementations, the memory storing instructions, which when executed by the processor, may further cause the processor to, in response to the FBVG-CCCM flag indicating FBVG-CCCM mode is not selected for the corresponding chroma block, generate a DBV mode prediction of the corresponding chroma block.

In some implementations, the memory storing instructions, which when executed by the processor, may further cause the processor to, in response to the FBVG-CCCM flag indicating the FBVG-CCCM mode is not selected for the corresponding chroma block, encode a chroma coding mode flag for the corresponding chroma block. In some implementations, the memory storing instructions, which when executed by the processor, may further cause the processor to, in response to the chroma coding mode flag having a first value, generate a CCCM mode prediction of the corresponding chroma block. In some implementations, the memory storing instructions, which when executed by the processor, may further cause the processor to, in response to the chroma coding mode flag having a second value, generate a DBV mode prediction of the corresponding chroma block.

In some implementations, the FBVG-CCCM flag may be signaled when a cbf_luma syntax element is non-zero.

In some implementations, the FBVG-CCCM mode may be enabled at one or more of an SPS level, a PH level, a PPS level, or an SH level.

According to still another aspect of the present disclosure, an apparatus for encoding is provided. The apparatus for encoding may include a processor and memory storing instructions. The memory storing instructions, which when executed by the processor, may cause the processor to, in response to a co-located luma block being coded using intraTMP or IBC, determine a corresponding chroma block is eligible for prediction using a FBVG-CCCM mode. The memory storing instructions, which when executed by the processor, may cause the processor to encode an FBVG-CCCM flag. The memory storing instructions, which when executed by the processor, may cause the processor to, in response to the FBVG-CCCM flag indicating the FBVG-CCCM mode is selected for the corresponding chroma block, generate a FBVG-CCCM mode prediction of the corresponding chroma block.

According to yet another aspect of the present disclosure, a non-transitory computer-readable medium storing instructions for an encoder is provided. The encoder may include a processor and memory storing instructions. The instructions, which when executed by the processor of the encoder, may cause the processor of the encoder to, in response to a co-located luma block being coded using intraTMP or IBC, determine a corresponding chroma block is eligible for prediction using a FBVG-CCCM mode. The instructions, which when executed by the processor of the encoder, may cause the processor of the encoder to encode an FBVG-CCCM flag. The instructions, which when executed by the processor of the encoder, may cause the processor of the encoder to, in response to the FBVG-CCCM flag indicating the FBVG-CCCM mode is selected for the corresponding chroma block, generate a FBVG-CCCM mode prediction of the corresponding chroma block.

In some implementations, to generate the FBVG-CCCM mode prediction of the corresponding chroma block, the memory storing instructions, which when executed by the processor, cause the processor to obtain a reference chroma block pointed to by a block vector (BV) of the corresponding chroma block (bvC). In some implementations, to generate the FBVG-CCCM mode prediction of the corresponding chroma block, the memory storing instructions, which when executed by the processor, cause the processor to generate a BVG-CCCM prediction of the corresponding chroma block. In some implementations, to generate the FBVG-CCCM mode prediction of the corresponding chroma block, the memory storing instructions, which when executed by the processor, cause the processor to multiply the reference chroma block with a first weighting factor. In some implementations, to generate the FBVG-CCCM mode prediction of the corresponding chroma block, the memory storing instructions, which when executed by the processor, cause the processor to multiply the BVG-CCCM prediction of the corresponding chroma block by a second weighting factor. In some implementations, to generate the FBVG-CCCM mode prediction of the corresponding chroma block, the memory storing instructions, which when executed by the processor, cause the processor to sum the reference chroma block multiplied by the first weighting factor and the BVG-CCCM prediction of the corresponding chroma block multiplied by the second weighting factor to generate the FBVG-CCCM mode prediction of the corresponding chroma block.

In some implementations, the instructions, which when executed by the processor of the encoder, may further cause the processor of the encoder to encode a chroma coding mode flag associated with the corresponding chroma block. In some implementations, the FBVG-CCCM flag may be encoded in response to the chroma coding mode flag indicating one of a DM, a DBV mode, or a CCCM mode for the corresponding chroma block.

In some implementations, the instructions, which when executed by the processor of the encoder, may further cause the processor of the encoder to, in response to the FBVG-CCCM flag indicating FBVG-CCCM mode is not selected for the corresponding chroma block, generate a CCCM mode prediction of the corresponding chroma block.

In some implementations, the instructions, which when executed by the processor of the encoder, may further cause the processor of the encoder to, in response to the FBVG-CCCM flag indicating FBVG-CCCM mode is not selected for the corresponding chroma block, generate a DBV mode prediction of the corresponding chroma block.

In some implementations, the instructions, which when executed by the processor of the encoder, may further cause the processor of the encoder to, in response to the FBVG-CCCM flag indicating the FBVG-CCCM mode is not selected for the corresponding chroma block, encode a chroma coding mode flag for the corresponding chroma block. In some implementations, the instructions, which when executed by the processor of the encoder, may further cause the processor of the encoder to, in response to the chroma coding mode flag having a first value, generate a CCCM mode prediction of the corresponding chroma block. In some implementations, the instructions, which when executed by the processor of the encoder, may further cause the processor of the encoder to, in response to the chroma coding mode flag having a second value, generate a DBV mode prediction of the corresponding chroma block.

In some implementations, the FBVG-CCCM flag may be signaled when a cbf_luma syntax element is non-zero.

In some implementations, the FBVG-CCCM mode may be enabled at one or more of an SPS level, a PH level, a PPS level, or an SH level.

According to still another aspect of the present disclosure, a non-transitory computer-readable medium storing a bitstream, the bitstream being generated according to one or more of the operations described herein.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

1. A method of decoding by a decoder, comprising:
in response to a co-located luma block being coded using intra template matching (intraTMP) or intra block copy (IBC), determining, by a processor, a corresponding chroma block is eligible for prediction using a fused block vector guided (FBVG)-convolutional cross-component intra prediction model (CCCM) (FBVG-CCCM) mode;
parsing, by the processor, a bitstream to obtain an FBVG-CCCM flag; and
in response to the FBVG-CCCM flag indicating the FBVG-CCCM mode is selected for the corresponding chroma block, generating, by the processor, a FBVG-CCCM mode prediction of the corresponding chroma block.

2. The method of claim 1, wherein the generating, by the processor, the FBVG-CCCM mode prediction of the corresponding chroma block comprises:
obtaining, by the processor, a reference chroma block pointed to by a block vector (BV) of the corresponding chroma block (bvC);
generating, by the processor, a block vector guided (BVG)-convolutional cross-component intra prediction model (CCCM) (BVG-CCCM) prediction of the corresponding chroma block;
multiplying, by the processor, the reference chroma block with a first weighting factor;
multiplying, by the processor, the BVG-CCCM prediction of the corresponding chroma block by a second weighting factor; and
summing, by the processor, the reference chroma block multiplied by the first weighting factor and the BVG-CCCM prediction of the corresponding chroma block multiplied by the second weighting factor to generate the FBVG-CCCM mode prediction of the corresponding chroma block.

3. The method of claim 1, further comprising:
parsing, by the processor, the bitstream to obtain a chroma coding mode flag associated with the corresponding chroma block,
wherein the bitstream is parsed to obtain the FBVG-CCCM flag in response to the chroma coding mode flag indicating one of a direct mode (DM), a direct block vector (DBV) mode, or a CCCM mode for the corresponding chroma block.

4. The method of claim 1, further comprising:
in response to the FBVG-CCCM flag indicating FBVG-CCCM mode is not selected for the corresponding chroma block, generating, by the processor, a CCCM mode prediction of the corresponding chroma block.

5. The method of claim 1, further comprising:
in response to the FBVG-CCCM flag indicating FBVG-CCCM mode is not selected for the corresponding chroma block, generating, by the processor, a direct block vector (DBV) mode prediction of the corresponding chroma block.

6. The method of claim 1, further comprising:
in response to the FBVG-CCCM flag indicating the FBVG-CCCM mode is not selected for the corresponding chroma block, parsing, by the processor, the bitstream to obtain a chroma coding mode flag for the corresponding chroma block;
in response to the chroma coding mode flag having a first value, generating, by the processor, a CCCM mode prediction of the corresponding chroma block; and
in response to the chroma coding mode flag having a second value, generating, by the processor, a direct block vector (DBV) mode prediction of the corresponding chroma block.

7. The method of claim 1, wherein the FBVG-CCCM flag is signaled when a cbf_luma syntax element is non-zero.

8. The method of claim 1, wherein the FBVG-CCCM mode is enabled at one or more of a sequence parameter set (SPS) level, a picture header (PH) level, a picture parameter set (PPS) level, or a slice header (SH) level.

9. A decoder, comprising:
a processor; and
memory storing instructions, which when executed by the processor, cause the processor to:
in response to a co-located luma block being coded using intra template matching (intraTMP) or intra block copy (IBC), determine a corresponding chroma block is eligible for prediction using a fused block vector guided (FBVG)-convolutional cross-component intra prediction model (CCCM) mode;
parse a bitstream to obtain an FBVG-CCCM flag; and
in response to the FBVG-CCCM flag indicating the FBVG-CCCM mode is selected for the corresponding chroma block, generate a FBVG-CCCM mode prediction of the corresponding chroma block.

10. The decoder of claim 9, wherein, to generate the FBVG-CCCM mode prediction of the corresponding chroma block, the memory storing instructions, which when executed by the processor, cause the processor to:
obtain a reference chroma block pointed to by a block vector (BV) of the corresponding chroma block (bvC);
generate a block vector guided (BVG)-convolutional cross-component intra prediction model (CCCM) (BVG-CCCM) prediction of the corresponding chroma block;
multiply the reference chroma block with a first weighting factor;
multiply the BVG-CCCM prediction of the corresponding chroma block by a second weighting factor; and
sum the reference chroma block multiplied by the first weighting factor and the BVG-CCCM prediction of the corresponding chroma block multiplied by the second weighting factor to generate the FBVG-CCCM mode prediction of the corresponding chroma block.

11. The decoder of claim 9, wherein the memory storing instructions, which when executed by the processor, further cause the processor to:
parse the bitstream to obtain a chroma coding mode flag associated with the corresponding chroma block,
wherein the bitstream is parsed to obtain the FBVG-CCCM flag in response to the chroma coding mode flag indicating one of a direct mode (DM), a direct block vector (DBV) mode, or a CCCM mode for the corresponding chroma block.

12. A method of encoding by an encoder, comprising:
in response to a co-located luma block being coded using intra template matching (intraTMP) or intra block copy (IBC), determining, by a processor, a corresponding chroma block is eligible for prediction using a fused block vector guided (FBVG)-convolutional cross-component intra prediction model (CCCM) (FBVG-CCCM) mode;
encoding, by the processor, an FBVG-CCCM flag; and
in response to the FBVG-CCCM flag indicating the FBVG-CCCM mode is selected for the corresponding chroma block, generating, by the processor, a FBVG-CCCM mode prediction of the corresponding chroma block.

13. The method of claim 12, wherein the generating, by the processor, the FBVG-CCCM mode prediction of the corresponding chroma block comprises:
obtaining, by the processor, a reference chroma block pointed to by a block vector (BV) of the corresponding chroma block (bvC);
generating, by the processor, a block vector guided (BVG)-convolutional cross-component intra prediction model (CCCM) (BVG-CCCM) prediction of the corresponding chroma block;
multiplying, by the processor, the reference chroma block with a first weighting factor;
multiplying, by the processor, the BVG-CCCM prediction of the corresponding chroma block by a second weighting factor; and
summing, by the processor, the reference chroma block multiplied by the first weighting factor and the BVG-CCCM prediction of the corresponding chroma block multiplied by the second weighting factor to generate the FBVG-CCCM mode prediction of the corresponding chroma block.

14. The method of claim 12, further comprising:
encoding, by the processor, a chroma coding mode flag associated with the corresponding chroma block,
wherein the FBVG-CCCM flag is encoded in response to the chroma coding mode flag indicating one of a direct mode (DM), a direct block vector (DBV) mode, or a CCCM mode for the corresponding chroma block.

15. The method of claim 12, further comprising:
in response to the FBVG-CCCM flag indicating FBVG-CCCM mode is not selected for the corresponding chroma block, generating, by the processor, a CCCM mode prediction of the corresponding chroma block.

16. The method of claim 12, further comprising:
in response to the FBVG-CCCM flag indicating FBVG-CCCM mode is not selected for the corresponding chroma block, generating, by the processor, a direct block vector (DBV) mode prediction of the corresponding chroma block.

17. The method of claim 12, further comprising:
in response to the FBVG-CCCM flag indicating the FBVG-CCCM mode is not selected for the corresponding chroma block, encoding, by the processor, a chroma coding mode flag for the corresponding chroma block;
in response to the chroma coding mode flag having a first value, generating, by the processor, a CCCM mode prediction of the corresponding chroma block; and
in response to the chroma coding mode flag having a second value, generating, by the processor, a direct block vector (DBV) mode prediction of the corresponding chroma block.

18. The method of claim 12, wherein the FBVG-CCCM flag is signaled when a cbf_luma syntax element is non-zero.

19. The method of claim 12, wherein the FBVG-CCCM mode is enabled at one or more of a sequence parameter set (SPS) level, a picture header (PH) level, a picture parameter set (PPS) level, or a slice header (SH) level.

20. A non-transitory computer-readable medium, having instructions and a bitstream stored thereon, wherein the instructions, when executed by a processor, enable the processor to perform the steps of the encoding method of claim 12 to generate the bitstream.
